(19) United States
(12) Patent Application Publication
(10) Pub. No.: US 2025/0294392 A1
(43) Pub. Date: Sep. 18, 2025

(54) TECHNIQUES FOR BEAM IDENTIFICATION FOR RADIO SENSING PARTICIPATION

(71) Applicant: Lenovo (Singapore) Pte. Ltd., Singapore (SG)

(72) Inventors: Seyedomid Taghizadeh Motlagh, Oberursel (DE); Ali Ramadan Ali, Kraiburg am Inn (DE); Karthikeyan Ganesan, Kronberg im Taunus (DE); Sher Ali Cheema, Ilmenau (DE)

(21) Appl. No.: 18/860,429

(22) PCT Filed: Apr. 25, 2023
(86) PCT No.: PCT/IB2023/054259

§ 371 Date: Oct. 25, 2024

Related U.S. Application Data
(60) Provisional application No. 63/334,619, filed on Apr. 25, 2022.

(51) Int. Cl. H04W 24/10; H04B 7/06; H04W 72/044

(52) U.S. Cl. CPC H04W 24/10; H04B 7/06952; H04W 72/044

(57) ABSTRACT

Various aspects of the present disclosure relate to techniques for beam identification for radio sensing participation. A UE is configured to receive a first configuration for performing and reporting radio sensing suitability measurements for radio sensing assistance associated with a radio sensing task, perform radio sensing suitability measurements for a radio sensing scenario according to the first configuration to determine whether the UE is suitable for providing the radio sensing assistance associated with the radio sensing task, transmit a suitability report comprising the performed radio sensing suitability measurements according to the first configuration, and receive a second configuration for performing radio sensing operations.

### FIELD

The subject matter disclosed herein relates generally to wireless communications and more particularly relates to techniques for beam identification for radio sensing participation.

### BACKGROUND

A wireless communications system may include one or multiple network communication devices, such as base stations, which may be otherwise known as an eNodeB (“eNB”), a next-generation NodeB (“gNB”), or other suitable terminology. Each network communication devices, such as a base station may support wireless communications for one or multiple user communication devices, which may be otherwise known as user equipment (“UE”), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (“3G”) radio access technology, fourth generation (“4G”) radio access technology, fifth generation (“5G”) radio access technology, among other suitable radio access technologies beyond 5G (e.g., sixth generation (“6G”)). In the wireless communications system, one or more of the network communication devices (e.g., base stations) or the user communication devices (e.g., UEs) may support one or multiple CG configurations for wireless communications (e.g., downlink communications, uplink communications).

### BRIEF SUMMARY

Disclosed are solutions for techniques for beam identification for radio sensing participation.

In one embodiment, a first apparatus includes a processor and a memory coupled to the processor. The memory includes instructions that are executable by the processor to receive a first configuration for performing and reporting radio sensing suitability measurements for radio sensing assistance associated with a radio sensing task, perform radio sensing suitability measurements for a radio sensing scenario according to the first configuration to determine whether the apparatus is suitable for providing the radio sensing assistance associated with the radio sensing task, transmit a suitability report comprising the performed radio sensing suitability measurements according to the first configuration, and receive, in response to the determining that the apparatus is suitable for providing the radio sensing assistance associated with the radio sensing task according to the performed radio sensing suitability measurements, a second configuration for performing radio sensing operations.

In one embodiment, a first method receives, at a UE, a first configuration for performing and reporting radio sensing suitability measurements for radio sensing assistance associated with a radio sensing task and performs, by the UE, radio sensing suitability measurements for a radio sensing scenario according to the first configuration to determine whether the UE is suitable for providing the radio sensing assistance associated with the radio sensing task. In one embodiment, the first method transmits, by the UE, a suitability report comprising the performed radio sensing suitability measurements to a network node according to the first configuration and receives, by the UE and in response to the UE being suitable for providing the radio sensing assistance associated with the radio sensing task according to the performed radio sensing suitability measurements, a second configuration for performing radio sensing operations.

In one embodiment, a second apparatus includes a processor and a memory coupled to the processor. The memory includes instructions that are executable by the processor to transmit, to a UE, a first configuration for performing and reporting radio sensing suitability measurements for radio sensing assistance associated with a radio sensing task, receive, from the UE, a suitability report comprising radio sensing suitability measurements performed according to the first configuration, determine, based on the radio sensing suitability measurements, whether the UE is suitable for providing the radio sensing assistance associated with the radio sensing task, and transmit, to the UE in response to the UE being suitable for providing the radio sensing assistance associated with the radio sensing task, a second configuration for performing radio sensing operations.

In one embodiment, a second method transmits, to a UE, a first configuration for performing and reporting radio sensing suitability measurements for radio sensing assistance associated with a radio sensing task and receives, from the UE, a suitability report comprising radio sensing suitability measurements performed according to the first configuration. In one embodiment, the second method determines, based on the radio sensing suitability measurements, whether the UE is suitable for providing the radio sensing assistance associated with the radio sensing task. In one embodiment, the second method transmits, to the UE in response to the UE being suitable for providing the radio sensing assistance associated with the radio sensing task, a second configuration for performing radio sensing operations.

### BRIEF DESCRIPTION OF THE DRAWINGS

FIG. 1 illustrates an example of a wireless communications system that supports techniques for beam identification for radio sensing participation in accordance with aspects of the present disclosure.

FIG. 2 illustrates an example diagram of different radio sensing scenarios that support techniques for beam identification for radio sensing participation in accordance with aspects of the present disclosure.

FIG. 3 illustrates an example diagram of different radio sensing scenarios that support techniques for beam identification for radio sensing participation in accordance with aspects of the present disclosure.

FIG. 4 illustrates an example diagram of a radio sensing scenario that support techniques for beam identification for radio sensing participation in accordance with aspects of the present disclosure.

FIG. 5 illustrates an example diagram of different radio sensing scenarios that support techniques for beam identification for radio sensing participation in accordance with aspects of the present disclosure.

FIG. 6 illustrates an example diagram of different radio sensing scenarios that support techniques for beam identification for radio sensing participation in accordance with aspects of the present disclosure.

FIG. 7 illustrates an example diagram of different radio sensing scenarios that support techniques for beam identification for radio sensing participation in accordance with aspects of the present disclosure.

FIG. 8 illustrates an example diagram of different radio sensing scenarios that support techniques for beam identification for radio sensing participation in accordance with aspects of the present disclosure.

FIG. 9 illustrates an example diagram of different radio sensing scenarios that support techniques for beam identification for radio sensing participation in accordance with aspects of the present disclosure.

FIG. 10 illustrates an example diagram of different radio sensing scenarios that support techniques for beam identification for radio sensing participation in accordance with aspects of the present disclosure.

FIG. 11 illustrates an example of a UE apparatus that supports techniques for beam identification for radio sensing participation in accordance with aspects of the present disclosure.

FIG. 12 illustrates an example of a network equipment (“NE”) apparatus that supports techniques for beam identification for radio sensing participation in accordance with aspects of the present disclosure.

FIG. 13 illustrates a flowchart of a method that supports techniques for beam identification for radio sensing participation in accordance with aspects of the present disclosure.

FIG. 14 illustrates a flowchart of a method that supports techniques for beam identification for radio sensing participation in accordance with aspects of the present disclosure.

### DETAILED DESCRIPTION

Generally, the present disclosure describes systems, methods, and apparatuses for techniques for beam identification for radio sensing participation. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Radio sensing is expected to appear in the future of the cellular wireless networks, both as a mechanism to improve the network performance, as well as an enabler to serve vertical use-cases. In particular, radio sensing obtains environment information by the means of transmission of a sensing excitation signal, e.g., a sensing reference signal (“RS”), from a network or UE entity, hereafter termed as sensing transmitting (“Tx”) node; reception of the reflections/echoes of the transmitted sensing excitation signal from the environment by a network or a UE entity, hereafter termed as sensing receiving (“Rx”) node; and processing of the received reflections and inferring relevant information from the environment.

In addition to the scenarios where network entities act as the sensing Tx and sensing Rx nodes, the scenarios of UE-based and/or UE-assisted sensing are of high interest, especially when the intended environment feature/information is used to enable a service at the same UE node. Furthermore, given the high-density presence of UE in most environments of interest, UE assisted sensing enables the use of distributed computation and energy resources of the UE nodes, as well as the more diverse and short-distance sensing coverage for sensing targets of interest. Example related use-cases include, but are not limited to, a need to detect potential physical obstacles, e.g., walking/movement assistance for a person with a disability, or a person walking in a foggy environment. Relative positioning may be needed with respect to a known reference/entity when UE location cannot be obtained via the available procedures.

In view of the above-mentioned use-cases, the identification of the appropriate sensing scenario, e.g., identification of the UE nodes that may act as a sensing Tx or sensing Rx node for a specific sensing task is non-trivial, considering limited UE computation, memory storage and energy resource, limited synchronization precision, as well as UE mobility and non-deterministic location/observability with respect to an object/area of interest.

In the current disclosure, we propose solutions to enable the determination of the appropriate UE nodes jointly with beam identification for sensing assistance in a communication network. In particular, solutions are proposed to the following problems: how the appropriate Tx/Rx beams for sensing in a SL or network-based radio sensing task can be identified and how the appropriate UE nodes jointly with the associated beams for sensing participation in a SL or network-based radio sensing task can be identified.

The proposed solutions may include a dedicated measurement configuration for sensing suitability determination at UEs jointly with beam identification/refinement, where the measurement and reporting include evaluation of the configured criteria, including line of sight (“LOS”)/non LOS (“NLOS”) reception as a condition for sensing suitability criteria, different LOS/NLOS reception report on different Rx filters, and UE stationarity condition with respect to an indicated beam/spatial filter/direction for an indicated time duration.

Further solutions are directed to joint or separate reporting on the Rx spatial filter/beam, where at least one suitability criteria may be reported for each Rx beam, joint or separate reporting on the Tx beam and Rx spatial filter pairs, where at least one suitability criteria may be reported for each beam pair, utilization of SL synchronization signals jointly for sensing suitability measurements, introduction of different SL resource pools with different waveform parameters for sensing and/or sensing suitability measurements in SL, and introduction of a subset of SL resource pools as search spaces for candidate UEs for sensing, for reception of related configuration messages.

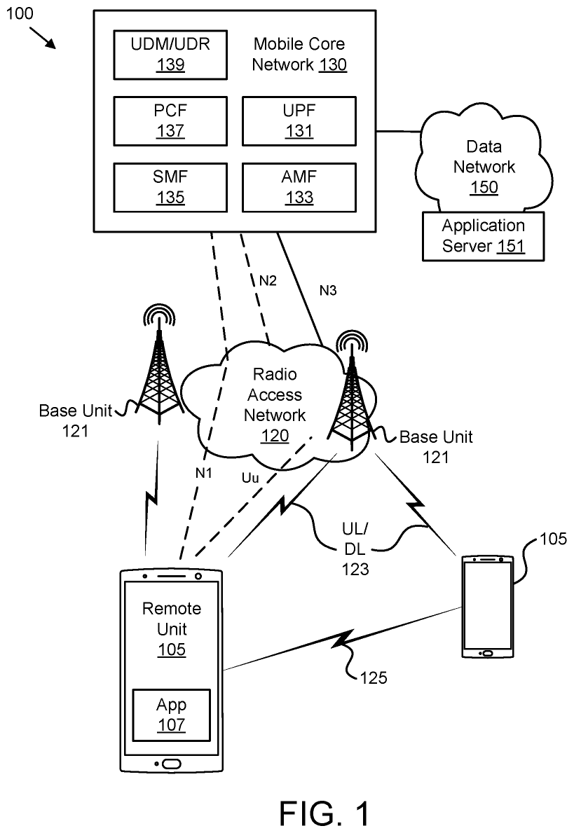

FIG. 1 depicts a wireless communication system 100 supporting techniques for beam identification for radio sensing participation, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-FiR or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM).

In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123.

Here, the RAN 120 is an intermediate network that provides the remote units 105 with access to the mobile core network 130. In one embodiment, remote units 105 may communicate with one another over a sidelink connection 125.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “‘attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”) 136, a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (DN), in the 5G architecture. The AMF 133 is responsible for termination of NAS signaling, NAS ciphering & integrity protection, registration management, connection management, mobility management, access authentication and authorization, and security context management. The SMF 135 is responsible for session management (i.e., session establishment, modification, release), remote unit (i.e., UE) IP address allocation & management, DL data notification, and traffic steering configuration for UPF for proper traffic routing.

The NEF 136 is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting CSI enhancements for higher frequencies.

The features defining UE capabilities for sensing, where UE acts as a sensing Tx for a sensing task associated with a sensing RS is defined via the set of the supported sensing RS patterns, including, but not limited to, the supported time-domain resource pattern for sensing RS, e.g., the maximum supported length of the sensing RS in time domain, maximum number of symbols or symbol density for sensing RS transmission, maximum supported power/energy for sensing RS transmission; the supported frequency-domain resource pattern for sensing RS, e.g., the maximum supported bandwidth of the sensing RS in freq. domain, maximum number of REs or RE density for sensing RS transmission, maximum supported power/energy for sensing RS transmission within a symbol or slot or a radio frame; the supported joint time-frequency domain resource pattern for sensing RS, e.g., the maximum supported number of total REs per radio frame for sensing RS transmission, maximum supported power/energy for sensing RS transmission within a symbol or a slot or a radio frame, the supported frequency hopping patterns; the supported spatial filters or beams or maximum supported number of simultaneously used spatial beams for sensing RS transmission; the supported guard interval or CP overhead for sensing symbols within sensing RS transmission; the supported computation/determination for choosing the sensing RS resource pattern among a set of possible patterns for sensing RS transmission; the supported computation/determination methods for choosing the sensing RS sequence among a set of possible sequences for sensing RS transmission; the supported sequence generation strategies or the supported sets of sequence-generation defining parameters for sensing RS transmission; and the supported sequence-to-resources mapping-defining parameter set for sensing RS pattern generation for transmission.

The features defining UE capabilities for sensing, where UE acts as a sensing Rx for a sensing task associated with a sensing RS is defined via the set of the supported sensing RS patterns, including, but not limited to, the supported time-domain resource pattern for sensing RS reception, e.g., the maximum supported length of the sensing RS in time domain, maximum number of symbols or symbol density for sensing RS reception, the supported frequency-domain resource pattern for sensing RS reception, e.g., the maximum supported bandwidth of the sensing RS in freq. domain, maximum number of REs or RE density for sensing RS reception, the supported joint time-frequency domain resource pattern for sensing RS reception, e.g., the maximum number of total REs per radio frame for sensing RS reception, the supported frequency hopping patterns for sensing RS reception, the supported spatial filters or beams or maximum number of simultaneously used spatial beams for sensing RS reception, the supported guard interval or CP overhead for sensing symbols within sensing RS reception, the supported detection/determination for a (partially) unknown received sensing RS resource pattern among a set of possible patterns for sensing RS reception, the supported detection/determination for a (partially) unknown received sensing RS sequence among a set of possible sequences, the supported sequence generation strategies for sensing RS transmission, and the supported sequence-to-resources mapping-defining parameter set for sensing RS reception.

The features defining UE capabilities for sensing, where UE acts jointly as a sensing Rx and sensing Tx (in a full-duplex fashion with simultaneous transmission and reception) for a sensing task associated with a sensing RS is defined via the set of the supported sensing RS patterns, including, but not limited to, the supported time-domain resource pattern for sensing RS joint transmission and reception, the supported frequency-domain resource pattern for sensing RS joint transmission and reception, the supported joint time/freq.-domain resource pattern including the supported frequency hopping patterns for sensing RS joint transmission and reception, the supported transmit and receive beam combinations for sensing RS joint transmission and reception, the supported transmit power, e.g., average transmit power during sensing, maximum average transmit power during sensing in any of the slots, maximum transmit power during any transmit symbol, total sensing RS energy, for sensing RS joint transmission and reception, the said features for the supported transmit power for sensing which are defined specific to a transmit beam or Tx/Rx beam combination supported for joint sensing RS transmission and reception, and features defining any allowed combination of the supported set of sensing RS for transmission and the supported set of sensing RS for reception.

The features defining UE capabilities for sensing RS multiplexing are including, but not limited to, the number of sensing RS that can be multiplexed within the same radio frame, or exist at the same time (e.g., exist when other ones are started and before the other ones are ended), the type of data/control channels or other RSs that can coexist with a sensing RS (e.g., exist after the said channel/RS starts and before the said channel/RS ends), the support of DFT spreading on the sensing RS, or the multiplexed sensing RS, and for all the above, the supported type of multiplexing.

The features defining UE capabilities for sensing measurements, where UE operates as sensing Rx is defined via the set of supported measurement types, including, but not limited to, the supported methods or computational models for sensing measurement (e.g., time-domain processing for time-of-flight estimation, CP-OFDM based doppler/range estimation, available computational/AI models for sensing measurements), the support of distance/range estimation, supported dynamic range of the object distance for estimation, supported distance estimation resolution, the support of object speed estimation, supported dynamic range of the object speed for estimation, supported speed estimation resolution, the support of the angular estimation (e.g., DoA estimation), supported dynamic range of the DoA for estimation, supported DoA estimation resolution, the maximum number of simultaneously supported objects for sensing measurements, and support of measurement features defined as the combination of any of the above features, e.g., support of DoA estimation for the objects with a specific distance dynamic range and a specific distance resolution.

The features defining UE capabilities for sensing measurements reporting, where UE operates as sensing Rx is defined via the set of supported measurement reporting types, including, but not limited to, type of the supported message/reporting (e.g., compression of the measurements or the estimated parameters or event-based reporting with a defined criterion), duration that a measurement message can be stored by the UE before transmission/reporting, the supported reporting criterion (e.g., comparing an estimated distance with a threshold, or computational models for checking a reporting criteria); and supported compression types for the reporting message.

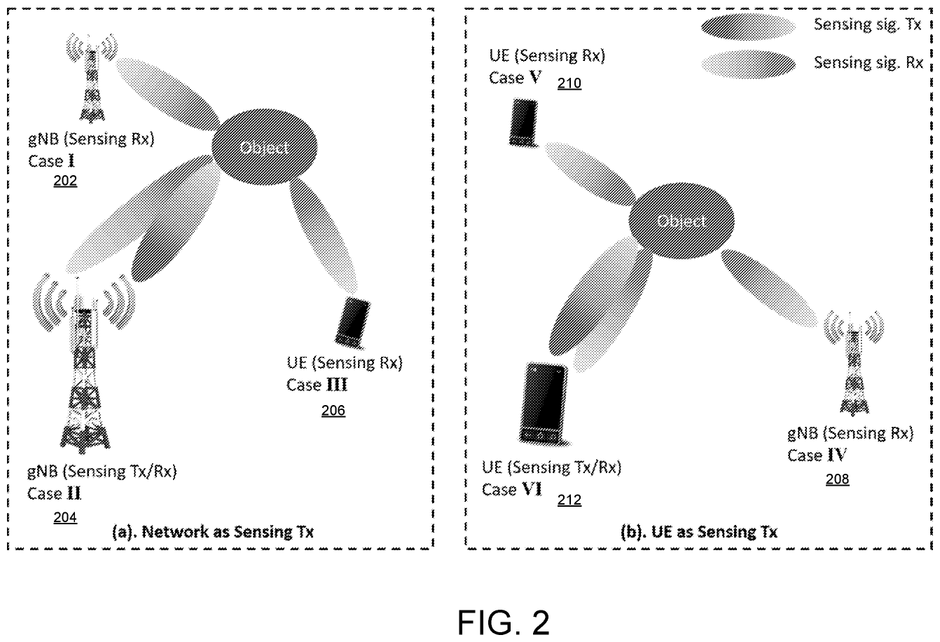

As shown in FIG. 2, the scenarios of network-based and UE-based (SL-based) radio sensing operations, and the conventional solutions, cover scenarios of radio sensing where the network configures the participating sensing entities, e.g., network and UE nodes acting as sensing Tx nodes, network and UE nodes acting as sensing Rx nodes, as well as the configuration of sensing RS and necessary measurements and reporting procedures from the nodes. In this regard, the functional split between the network and the UE nodes for a specific sensing task may take various forms, depending on the availability of sensing-capable devices and the requirements of the specific sensing operation.
Case I 202—Sensing Tx as a network node and Sensing Rx as a separate network node: in this case, the sensing RS (or another RS used for sensing, or the data/control channels known to the network TRP nodes) is transmitted and received by network entities. The involvement of UE nodes are limited to the aspects of interference management, when necessary. The network does not utilize UEs for sensing assistance in this scenario.
Case II 204—Sensing Tx as a network node and Sensing Rx as the same network node: the sensing RS (or another RS used for sensing, or the data/control channels known to the network TRP nodes) is transmitted and received by the same network entity. The involvement of UE nodes are limited to the aspects of interference management, when necessary. The network does not utilize UEs for sensing assistance in this scenario.
Case III 206—Sensing Tx as network node and Sensing Rx as a UE node: in this case, the sensing RS or other RS used for sensing is transmitted by a network entity and received by one or multiple UE nodes. The network configures the UEs to act as a sensing Rx node, according to the UE nodes capabilities for sensing, as well as desired sensing task.
Case IV 208—Sensing Tx as a UE node and Sensing Rx as a network node: in this case, the sensing RS or other RS used for sensing (or a data/control channel transmitted by the UE) is received by one or multiple network entities and transmitted by a UE node. The network configures the UE to act as a sensing Tx node, according to the UE nodes capabilities for sensing, as well as the nature of the desired sensing task.
Case V 210—Sensing Tx as a UE node and Sensing Rx as a separate UE node: in this case, the sensing RS or other RS used for sensing is received by one or multiple UE nodes and transmitted by a UE node. In this case, the network, or a UE node may potentially decide on configuration of the sensing scenario. In one instance, the network configures the UEs to act as a sensing Tx and/or sensing Rx nodes, according to the UE nodes capabilities for sensing, as well as the nature of the desired sensing task.
Case VI 212—Sensing Tx as a UE node and Sensing Rx as the same UE node: in this case, the sensing RS (or another RS used for sensing, or the data/control channels known to the UE) is transmitted by a UE node and received by the same UE node. In this case, the UE or the network configures the sensing scenario, according to the UE nodes capabilities for sensing, as well as the nature of the desired sensing task.

In the current disclosure, the determination of the appropriate UE nodes is enabled and enhanced, together with the associated beams for sensing assistance, in a network-based or a UE/SL-based sensing task via the following high-level solutions: Dedicated measurement and reporting for UE suitability determination and beam identification in a network-based sensing scenario; Dedicated measurement and reporting for UE suitability determination and beam identification in a SL/UE-based sensing scenario; Dedicated measurement and reporting for UE beam refinement in a network-based sensing scenario; and Dedicated measurement and reporting for UE beam refinement in a SL/UE-based sensing scenario.

According to a first embodiment, the determination of the suitable UE nodes for participation in a sensing task jointly with the identification of the appropriate UE beams for sensing are done based on transmission of a suitability determination configuration by a first network node towards one or multiple UE nodes as candidates for participation in a sensing task. The suitability determination configuration may include a set of time/frequency resources for transmission of a reference signal for suitability measurement/determination by the UE; an indication of the transmitted reference signal for suitability measurement/determination by the UE;

criteria for stationarity conditions of the candidate node for sensing with respect to a sensing target object/area of interest based on the performed measurements; criteria for observability of the target object/area of interest for the candidate node for sensing based on the performed measurements; sensing capability and readiness/availability of the candidate node for sensing participation, including energy, memory storage, processing capability or a combination thereof, related to a sensing task; and/or an indication of the type of a report to be transmitted to the first network node or to another node, based on the performed measurements, according to the suitability determination configuration.

Subsequently, in one embodiment, the candidate UE nodes for participating in a sensing task will respond to the perform the measurements and report the performed measurements according to the suitability determination configuration. In one embodiment, as a result of the transmitted configuration and the received response, the first network node refines the group of candidate network nodes for participating in the said sensing task by eliminating the candidates which do not satisfy some suitability criterion, thereby building a new group of the candidate network nodes; assigns an identifier number to the identified group of network nodes for sensing participation; determines a group of network nodes for sensing participation based on the received query and response messages; determines the beam for the identified assisting UEs for sensing participation; and/or configures a sensing operation where the identified UE nodes with the associated beams participate in the sensing operation as sensing Tx and/or sensing Rx or a combination thereof.

In some embodiments, the information elements included in the sensing suitability query, in case of network-based sensing and/or the information elements included in SL sensing request message for the SL-based sensing scenarios, are included in the suitability determination configuration, defining the suitability criteria for UE participation.

In some embodiments, the transmission of the suitability determination configuration and the report, as well as the subsequent configurations of a radio sensing task are transmitted via the physical control/data channels.

In the following embodiments and implementations, the measurements configuration for scenario suitability determination is assumed as an integral part of the SL sensing request or the sensing suitability query, or interchangeably considered as a configuration separately transmitted for the purpose of suitability measurements.

According to a second embodiment directed to joint UE and beam identification for network-based UE-assisted sensing, the determination of the suitable UE nodes for participation in a network-based UE-assisted sensing task are done based on the transmission of a sensing suitability query message by the network towards one or multiple candidate UE nodes for participation in a sensing task as well as the measurements configuration for the purpose of suitability evaluation by the UE. Subsequently, the candidate UE node for sensing, in one embodiment, will respond to the sensing suitability query message and/or transmit a measurement report, reporting on the node suitability for sensing.

In one embodiment, as a result of the transmitted query and the received response/report, the network node identifies the suitable UE nodes and the associated beam for sensing, refines the group of candidate UE nodes and construct a new group of candidate UE nodes for the said sensing task, assigns an identifier number to the identified group of UE nodes, configures a sensing operation on the identified group of UE nodes and the identified associated beams, or a combination thereof.

It is understood that this embodiment is not limited to the implementation elements individually, and one or more elements from one or more implementations and/or embodiments may be combined.

In an implementation directed to measurements for UE beam and suitability determination for sensing, in addition to the UE identification for a specific sensing task with UE assistance, in one embodiment, the corresponding reception beam at the assisting UE may need to be identified for a specific sensing task. According to this embodiment, the UE reception beam for sensing is determined based on the sensing suitability query, the configured measurements are determined according to the sensing suitability query, the response message is determined according to the sensing suitability query, or some combinations thereof.

In some embodiments, when an object of interest for sensing/monitoring is determined to be present by the network, during the determined period of the object presence, the network/gNB transmits a reference signal towards the object, where the UE or a group of candidate UEs for sensing participation are indicated to perform suitability determination and/or to perform measurements and transmit a report to the network for suitability evaluation, according to the configurations received in the sensing suitability query message. In some embodiments, the determination of a NLOS reception condition for the receive beam at the UE is indicated as a requirement for the sensing UE and/or sensing Rx beam determination in the sensing suitability query message.

In some embodiments, when an object of interest for sensing is determined to be not present by the network, or when the intention of a sensing task is to monitor an area occupancy, or a dynamic blockage event in an otherwise blockage-free direction/area, the network/gNB transmits a reference signal towards the area of interest to be monitored, where the UE or a group of candidate UEs for sensing participation are indicated to perform suitability determination and/or to perform measurements and report related to the suitability evaluation, according to the configurations received in the sensing suitability query message. In some embodiments, the determination of a LOS reception condition for the receive beam at the UE is indicated as a requirement for the sensing UE and/or sensing Rx beam determination in the sensing suitability query message.

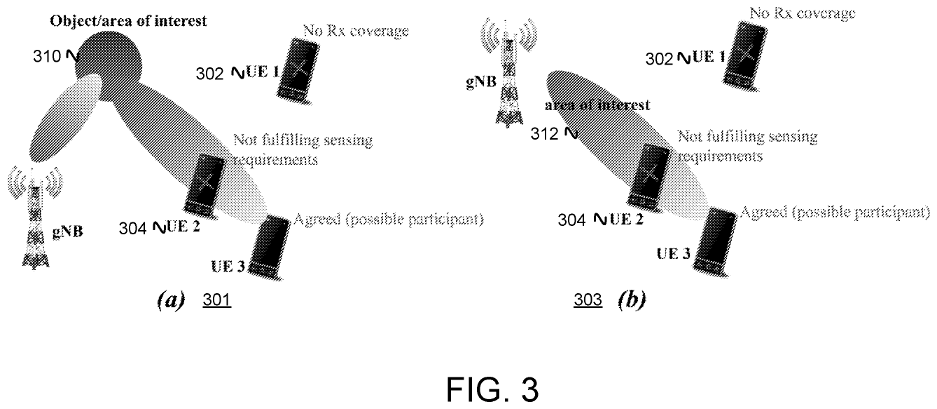

An example scenario is depicted in FIG. 3, for the case where the object of interest 310 is present (a) 301 and when the object of interest 310 is not present (b) 303 and the sensing task involves monitoring of an area of interest 312. In this example, UE 1 302 is not identified as a suitable UE for sensing assistance, due to, e.g., insufficient Received Signal Strength Indicator (“RSSI”) or Reference Signal Received Quality (“RSRQ”) according to a criteria defined within sensing suitability query message. UE 2 304 is located with a sufficient reception quality, e.g., the condition on the RSRQ, however, it may not satisfy the required stationarity condition for sensing or other sensing-related capability indicated within the sensing suitability query message.

In one embodiment, the UE is requested to perform measurements on the transmitted RS and report the received value to the network, according to the received configuration. In some embodiments, the performed measurements and the needed reporting values include the received Reference Signal Received Power (“RSRP”) or RSRQ or RSSI or some combination thereof, on the configured resources. In some embodiments, UE is indicated to report to the network only if some conditions are met, according to the configuration within the sensing suitability query message, e.g., when the received RSRP and/or RSRQ on a beam exceeds an indicated threshold with the specified NLOS condition.

In some embodiments, the UE stationarity during a time period of interest for sensing is considered as a criterion for suitability determination, either by the network or as indicated to the UE. In some embodiments, a time duration is indicated to the UE for which the UE's orientation must not deviate from the indicated beam with an indicated angular margin/threshold and/or a UE's location must not exceed an indicated displacement threshold.

In some embodiments, the UE suitability determination depends on the expected role in the sensing operation, e.g., as a sensing Rx or as a sensing Tx. In some embodiments, when UE is expected to act as a sensing Tx, the energy/battery life will be considered as a suitability criterion. In some embodiments, when the UE is expected to act as a sensing Rx, the energy/battery life, memory/storage or computational power or some combinations thereof is considered as a suitability criterion.

In some embodiments, the sensing suitability query message is sent via the same beam as for the RS transmissions for measurements, as configured by sensing suitability query. In some embodiments, the UE are indicated to store the decoded sensing suitability query message content as a known symbol sequence or a compressed/quantized version thereof, store the received signal at the receive antenna port and use the decoded symbol sequence to perform required measurements according to the measurement configurations within sensing suitability query.

According to another embodiment directed to beam refinement for network-based UE-assisted sensing with a UE as a sensing Rx, the UE reception beam for sensing is determined based on the sensing suitability query, and a plurality of measurements performed by the candidate UE according to sensing suitability query, the response message to the sensing suitability query including a report from the performed plurality of measurements, or some combinations thereof.

In some embodiments, the network configures separately a set of sensing suitability query messages whereby a set of RS transmission, measurement, and reporting configurations are indicated to the candidate UE.

In some embodiments, the configured multiple measurements for the sensing UE and/or beam identification correspond to different network Tx beam or antenna port or a transmission/reception point (“TRP”) or a combination thereof from which the RS for measurements are transmitted.

In some embodiments, the configured multiple measurements for the sensing UE and/or beam identification/refinement are different in the applied Rx UE beam, where the UE performs measurements over multiple beam/multiple directions to refine the Rx beam for sensing. In some embodiments, multiple UE receive beam measurements at the same UE may be performed at the same time, or multiple beam measurements may be multiplexed in time with an indicated time-ratio or multiplexing configuration, or a combination thereof. In some embodiments, a strategy for the determination of the multiple Rx beams participating in the sensing measurements and a multiplexing configuration thereof is included in the measurement configuration sent by the network.

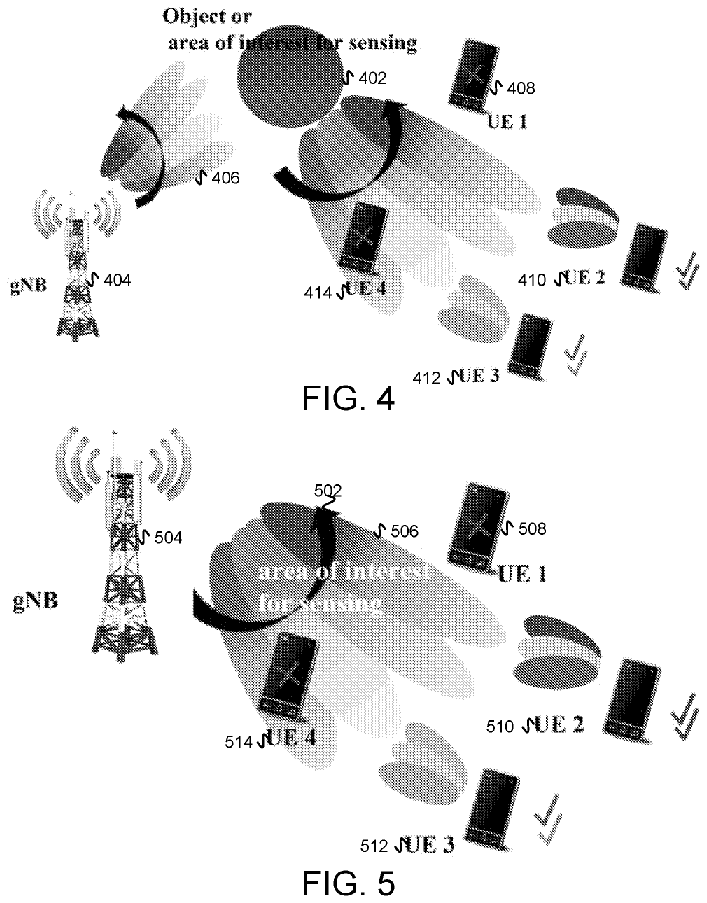

FIG. 4 depicts a scenario where a gNB 404 transmits multiple RSs for measurements via different beams towards an object of interest 402, the candidate UEs 408-414 for sensing may perform measurements from the reflected wave from the object of interest 402 via multiple Rx beams and report to the network 404, according to the configuration received via the sensing suitability query message.

As depicted in FIG. 4, in some embodiments, when an object of interest 402 for sensing/monitoring is determined to be present by the network 404, during the determined period of the object presence, the network/gNB 404 performs multiple reference signal transmission 406 towards the object of interest 402 via multiple beam, multiple antenna port, multiple TRPs, or a combination thereof, where the UE or a group of candidate UEs 408-414 for sensing participation are indicated to perform suitability determination and/or to perform measurements and transmit a report to the network 404 for suitability evaluation, according to the configurations received in the sensing suitability query message.

In some embodiments, the determination of an NLOS reception condition for the receive beam at the UE, separately for each transmitted RS or jointly for all/subset of the transmissions, are indicated as a requirement for the sensing UE and/or sensing Rx beam determination in the sensing suitability query message.

FIG. 5 depicts a scenario where a gNB 504 transmits multiple RSs for measurements via different beams towards an area of interest 502, the candidate UEs 508-514 for sensing may perform measurements from the received LoS wave via multiple Rx beams and report to the network, according to the configuration received via the sensing suitability query message.

In some embodiments, as depicted in FIG. 5, when an object of interest for sensing is determined to be not present by the network, or when the intention of a sensing task is to monitor an area occupancy, or a dynamic blockage event in an otherwise blockage-free direction/area, the network/gNB 504 perform multiple RS transmissions 506 towards the area of interest 502 to be monitored via multiple beams, multiple antenna ports, multiple TRPs, or a combination thereof, where the UE or a group of candidate UEs 508-514 for sensing participation are indicated to perform suitability determination and/or to perform measurements over one or multiple Rx beams and report related to the suitability evaluation, according to the configurations received in the sensing suitability query message.

In some embodiments, the determination of a LOS reception condition for the receive beam at the UE is indicated as a requirement for the sensing UE and/or sensing Rx beam determination, where the LoS determination is done jointly for all of the configured RS resources, or individually, or jointly for subset of the configured RS resources, according to the configuration in the sensing suitability query message.

In some embodiments, a single sensing suitability query message or a single sensing suitability query or a configuration message is used to schedule the plurality of measurements over multiple beams of the same UE, or measurements over multiple candidate UEs where the message is transmitted via a group-common signaling, or a combination thereof.

In some embodiments, some of measurement configuration parameters are constant for multiple measurements or defined relatively. In one implementation, the criterion for UE stationarity and/or the required RSRQ may be defined similarly for multiple measurements, but the time/frequency pattern for related measurements may be multiplexed in time or frequency or code domain and defined with respect to a previously scheduled measurement with an indicated shift in time domain and/or frequency domain and/or code index.

In some embodiments, the UE is requested to send a separate response to each sensing suitability query and/or to send a separate report for the conducted measurements, corresponding to the different UE Rx beam measurements and/or different configured network RS Tx resources/beams for UE measurements. In some embodiments, the UE is requested to send a joint response to multiple received sensing suitability query and/or to send a joint report for the conducted measurements, corresponding to the different UE Rx beam measurements and/or different network RS Tx beams.

In some embodiments, when UE performs measurements over multiple Rx beams, UE transmits a report only on the best identified beam, or a number of the best identified beams, or on the identified beams that satisfy some conditions (e.g., exceeding a threshold on the RSRQ together with some stationarity condition for the measured beam direction) according to the criteria indicated within the sensing suitability query message.

In some embodiments, when UE performs measurements over multiple Rx beams and/or different network RS Tx beams (where each network beam correspond to a different RS resource), UE transmits a report only on the best identified UE Rx beam for a corresponding Tx beam, or a number of the best identified UE Rx beams for a corresponding Tx beam, or the identified UE Rx beams for a corresponding Tx beam that satisfy an indicated condition, or a best network Tx beam or a number of the identified best network beams, or the identified network beams that satisfy some conditions or the best pair of network Tx beam and the UE Rx beams or a number of the best pairs of network Tx beam and the UE Rx beams, or the identified pairs of network Tx beam and the UE Rx beams that satisfy an indicated condition, according to the criteria indicated within the sensing suitability query message. In some embodiments, the obtained measurements are jointly compressed over the multiple Rx beams, multiple Tx network beams or a combination thereof and transmitted to the network as a joint report according to a configuration indicated within the sensing suitability query message.

In some embodiments, upon reception of sensing suitability query message response from candidate sensing UEs, where sufficient suitable sensing candidates/beams are identified, the network terminates the configured measurement task by indicating a de-activation for the remaining configured measurement and reporting procedures.

In some embodiments, the previously identified candidate UEs via a UE identification for UE-assisted sensing procedure are considered as a group for the configuration of further beam refinement and/or UE determination procedure. In one embodiment, the previously identified candidate UEs will receive sensing suitability query and measurement configurations via a group signaling. In one embodiment, a larger set of candidate UEs receive the sensing suitability query and measurement configurations, but only the UEs previously identified as a feasible UEs for sensing assistance and/or the beams previously identified for sensing assistance are activated/required to participate in the configured measurements and/or reporting.

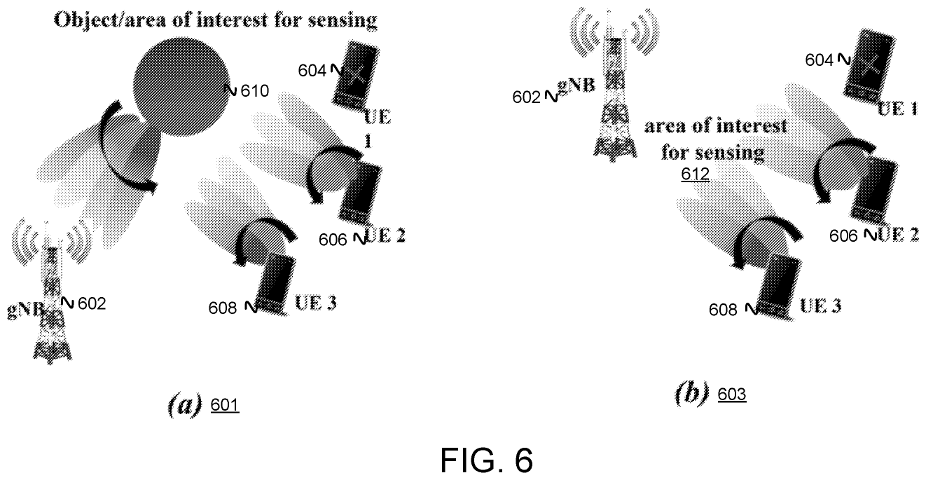

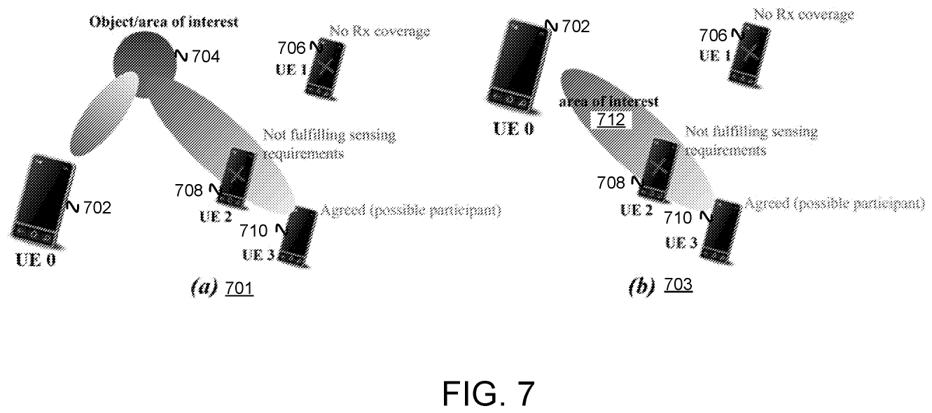

FIG. 6 depicts a situation where UEs 604-608 transmit RSs according to the received configuration for the purpose of UE Tx beam refinement for sensing, where the RS transmissions are scheduled by the network 602 towards an object of interest 610, when the object of interest is determined to be present (case (a) 601), and towards an area of interest 612 to be monitored (case (b) 603).

In another embodiment directed to joint UE and beam identification for Network-based UE-assisted sensing with UE as sensing Tx, when an assisting UE node for sensing is required to operate as a sensing Tx, in addition to the UE identification for a specific sensing task with UE assistance, the corresponding transmission beam from the assisting UE need to be identified. According to this embodiment, the UE Tx beam for sensing is determined based on the transmission of a sensing suitability query by the network, the configured measurements according to sensing suitability query, the response message to the sensing suitability query or some combinations thereof.

In some embodiments, the indication of the UE Tx beam includes indication of a quasi co-location (“QCL”) type-D relation to a previously used signal or beam. In some embodiments, the Tx beam indication for the assisting UE is done via the QCL type-D relation to one or multiple Rx beams identified via the procedures stated above, for Rx beam identification/refinement.

In some embodiments, the UE Tx beam for sensing is identified based on the transmission of RS by UE nodes and measurements by the network. In some embodiments, the Tx beams for each UE is identified via a QCL type-D relation to another beam, e.g., the number N of the Tx beams closest to an indicated/known beam at the UE.

In some embodiments, the transmission of the RS by the candidate UEs are based on a prior UE identification and/or beam refinement procedure for sensing UEs operating as sensing Rx. In some embodiments, only the UEs previously identified via the same procedure for sensing Rx UE identification are considered for the UE identification and/or beam refinement for UE identification as sensing Tx.

In some embodiments, the RS transmissions from the UEs are scheduled with resources where the Tx RS resources are separated in time or in frequency or code domain or a combination thereof for all UEs and all Tx beams. In some embodiments, one multiplexing type is used for the Tx beams over the same UE and the same antenna port, whereas one (potentially different) multiplexing type is use for Tx beams over different antenna ports but at the same UE, whereas one (potentially different) multiplexing type is used for the Tx beams over different UEs.

In one embodiment, the RS resources are defined and indicated separately for each UE. In some embodiments, the RS resources are jointly defined and indicated to the UE via a group signaling, towards a group including the candidate UEs.

According to another embodiment directed to a signaling and message exchange procedure, the known UL and DL physical channels to transmit data and/or control information within the network are used to convey the sensing suitability query message, the sensing suitability query message response, related configurations for the message/response, configurations for the needed measurements, as well as the measurements reports by the UE.

In some embodiments, the RS used for the purpose of UE and/or beam identification/refinement for sensing is a sensing specific RS, sensing specific RS for DL (when the measurement RS is transmitted by the network), sensing specific RS for UL (when the measurement RS is transmitted by the candidate UEs) or an RS defined specifically for sensing UE/beam determination. In some embodiments, an existing RS is used for the purpose of UE and/or beam identification/refinement for sensing, where the RS configuration is done according to the parameters defining the used RS. In some embodiments, some of the parameters defining the used RS for the purpose of the sensing UE and determination are configured semi-statically (remain constant over multiple usage of the RS for related measurements) and others dynamically (changed according to each use-case).

In some embodiments, the sensing suitability query message and/or the related measurements configuration is transmitted dynamically, via a downlink control information (“DCI”) or a group common DCI, semi-statically via radio resource control (“RRC”) message, or via a broadcast message, e.g., system information block (“SIB”). In some embodiments, the configuration for the sensing suitability query message, the type of the sensing suitability query message, the configuration for the sensing suitability query message response or a combination thereof are transmitted via RRC signaling, or a multicast signaling to a group of candidate UEs dynamically via DCI with cyclic redundancy check (“CRC”) scrambled with a group-common radio network temporary identifier (“RNTI”), via individual DCI, or a broadcast signaling via a SIB, or via RRC signaling.

In some embodiments, the associated measurement resources for sensing suitability determination and/or beam refinement are a semi-persistent resource configured via RRC signaling, with activation indicated via a medium access control (“MAC”) control element (“CE”) or an individual DCI indication or a group common DCI. In some embodiments, where the associated measurement resources configured via RRC signaling, the type of the required measurement, reporting configuration, and UE/beam determination strategy are indicated together with an activation MAC-CE or an individual DCI indication or a group common DCI, or a combination thereof.

In some embodiments, the type/format of the sensing suitability query message is signaled to the UE dynamically, via a DCI or a group common DCI, semi-statically via RRC message, or via a broadcast message, e.g., SIB. In one implementation, this includes the indication of an index from a codebook, where the codebook includes the possible sensing suitability query message format.

In some embodiments, the type/format of the sensing suitability query message response is signaled to the UE to the UE dynamically, via a DCI or a group common DCI, semi-statically via RRC message, or via a broadcast message, e.g., SIB. In one implementation, this includes the indication of an index from a codebook, where the codebook includes the possible sensing suitability query message response formats. In some embodiments, the response message and/or the measurements report message are transmitted via an uplink control information element uplink control information (“UCI”) via physical uplink control channel (“PUCCH”) or via physical uplink shared channel (“PUSCH”).

According to another embodiment directed to joint UE and beam identification for SL-based sensing, the determination of the suitable UE nodes and the associated beams for participation in a SL-based sensing task are done based on the transmission of a SL Sensing Request message by the network towards one or multiple candidate UE nodes for participation in the sensing task, including the configuration for suitability measurements, and performing the configured measurements.

Subsequently, in one embodiment, the candidate UE node for SL sensing will respond to the SL Sensing Request message, reporting on the node suitability for sensing based the prior knowledge of the UE and/or environment, as well as the performed measurements according to the received configuration. As a result of the transmitted SL Sensing Request message and the received response, the requesting UE node determines the associated beam for SL sensing at the candidate UEs, identifies the suitable UEs for participating in the SL sensing task, refines the group of candidate UE nodes and constructs a new group of candidate UE nodes for the said sensing task, assigns an identifier number to the identified group of UE nodes, configures a sensing operation on the identified group of UE nodes, or a combination thereof. It is understood that this embodiment is not limited to the implementation elements individually, and one or more elements from one or more implementations and/or embodiments may be combined.

In another embodiment directed to SL measurements for sensing UE and beam identification, in addition to the message exchange for identification of the candidate UEs for SL sensing, dedicated measurements may be needed to identify the properly positioned and capable UEs for a sensing scenario of interest in SL. This is needed, e.g., when the observability of an object/area of interest by a candidate UE and/or the respective beam at a candidate UE for sensing may not be known by the UE, when UE is not in a connected mode and hence may not send a request message to the network for sensing scenario identification/configuration, or when such information is also not available at the network.

According to this embodiment, SL Sensing Request message includes an indication for the activation of a previously configured resources for SL measurements for sensing UE and/or beam identification or includes dedicated configuration for such measurements. Alternatively, dedicated configuration for such measurements may be sent and/or activated separately from the SL Sensing Request message. Thereby, the sensing UE suitability determination for a SL sensing task can be done based to the performed measurements.

In some embodiments, the configuration of sensing suitability measurements includes a set of time/frequency and beam resources over which the sensing suitability measurements will be done.

In some embodiments, the configuration of sensing suitability measurements includes a set of measurement types, e.g., RSRP, RSRQ, RSSI. In some embodiments, the measured values of RSRP, RSRQ, RSSI are specific to an indicated beam/angle in the direction of the object/area of interest.

In some embodiments, the SL Sensing Request message includes a set of measurement criterion according to which UE sensing suitability, or a subset of sensing suitability criterions are determined for SL sensing, according to the performed measurements, e.g., a threshold on the min RSRQ measurement value for suitability over an indicated beam/direction, combined with the LoS determination condition. In one implementation, the determination of the LoS/NLOS conditions towards an object/area of interest is done in accordance with a configuration received from the network, or a configuration defined within the SL Sensing Request message and the performed measurements.

In some embodiments, when an object of interest for sensing/monitoring is determined to be present by the requesting UE for SL sensing, during the determined period of the object presence, the requesting UE transmits a reference signal towards the object, where the UE or a group of candidate UEs for sensing participation are indicated to perform suitability determination and/or to perform measurements and transmit a report to the network for suitability evaluation, according to the received configurations. In some embodiments, the determination of a NLOS reception condition for the receive beam at the UE is indicated as a requirement for the sensing UE and/or sensing Rx/Tx beam determination.

In some embodiments, when an object of interest for sensing is determined to be not present by the present by the requesting UE for SL sensing, or when the intention of a sensing task is to monitor an area occupancy, or a dynamic blockage event monitoring in an otherwise blockage-free direction/area, the UE transmits a reference signal towards the area of interest to be monitored, where the UE or a group of candidate UEs for SL sensing participation are indicated to perform to perform measurements and report related to the suitability evaluation, according to the received configuration. In some embodiments, the determination of a LOS reception condition for the receive beam at the UE is indicated as a requirement for the sensing UE and/or sensing Rx beam determination.

FIG. 7 depicts a scenario where a requesting UE 702 for SL sensing (UE 0) transmits an RS via a beam directed at an object of interest 704, in case (a) 701, or at an area of interest 712, in case (b) 703, for SL sensing UE and/or beam identification. Based on the measurements of the received RS, the UE 706-710 satisfying or not-satisfying the suitability criterion may indicate the suitability and/or a measurement report to the network via a response message.

In this example, UE 0 702 is the requesting UE for SL sensing, whereas UE 1 706 is not identified as a suitable UE for sensing assistance, due to, e.g., insufficient RSSI or RSRQ according to a received configuration, e.g., via the SL Sensing Request message. UE 2 708 is located with a sufficient reception quality, e.g., the condition on the RSRQ, however, it may not satisfy the required stationarity condition for sensing, or energy, or processing/measurement capability for SL sensing.

In one embodiment, the UE 710 is requested to perform measurements on the transmitted RS and report the received value to the UE 702, according to the received configuration. In some embodiments, the performed measurements and the needed reporting values include the received RSRP or RSRQ or RSSI or some combination thereof, on the configured resources. In some embodiments, UE 710 is indicated to report to the network only if some conditions are met, according to the received configuration, e.g., when the received RSRP and/or RSRQ on a beam exceeds an indicated threshold with the specified NLOS condition.

In some embodiments, the UE 710 stationarity during a time period of interest for sensing is considered as a criterion for suitability determination, either by the network or as indicated to the UE 702. In some embodiments, a time duration is indicated to the UE 710 for which the UE's orientation must not deviate from the indicated beam with an indicated angular margin/threshold and/or a UE's location must not exceed an indicated displacement threshold.

In some embodiments, the UE suitability determination depends on the expected role in the sensing operation, e.g., as a sensing Rx or as a sensing Tx. In some embodiments, when UE 710 is expected to act as a sensing Tx, the energy/battery life will be considered as a suitability criterion. In some embodiments, when UE is expected to act as a sensing Rx, the energy/battery life, memory/storage or computational power or some combinations thereof is considered as a suitability criterion.

In some embodiments, the SL Sensing Request message and/or the configuration for measurements for SL UE/beam identification are QCL type-D with the RS transmitted for SL UE/beam identification measurements. In some embodiments, the candidate UEs 706-710 are indicated to store the decoded SL Sensing Request and/or the received configuration message, and thereby use the received signal as a known symbol sequence or a compressed/quantized version thereof, store the received signal at the receive antenna port and use the decoded symbol sequence to perform required measurements according to the received measurement configuration.

According to another embodiment directed to beam refinement for SL-based sensing, the UE reception beam for SL sensing is determined based on plurality of measurements performed by the candidate UE according to the SL Sensing Request message and/or the received measurement configurations for SL sensing.

In some embodiments, the requesting UE for SL sensing configures separately a set of SL Sensing Request messages, set of RS transmission, measurement and reporting configurations are indicated to the candidate UEs for SL sensing.

In some embodiments, the configured multiple measurements for sensing UE and/or beam identification correspond to different requesting UE Tx beam or antenna port or a combination thereof from which the RS for measurements are transmitted.

In some embodiments, the configured multiple measurements for sensing UE and/or beam identification/refinement are different in the applied Rx beam at the candidate UE, where the candidate UE performs measurements over multiple beam/multiple directions to refine the Rx beam for sensing. In some embodiments, multiple UE receive beam measurements at the same UE may be performed at the same time, or multiple beam measurements may be multiplexed in time with an indicated time-ratio or multiplexing configuration, or a combination thereof. In some embodiments, a strategy for the determination of the multiple Rx beams participating in the sensing measurements and a multiplexing configuration thereof is included in the measurement configuration for SL sensing UE/beam identification.

FIG. 8 depicts a scenario where a requesting UE 804 for SL sensing (UE 0) transmits multiple RS 806 for measurements via different beams towards an object of interest 802, the candidate UEs 808-814 for sensing may perform measurements from the reflected wave from the object of interest via multiple Rx beams and report to the network, according to the configuration received via the sensing suitability query message.

As depicted in FIG. 8, in some embodiments, when an object of interest 802 for sensing/monitoring is determined to be present by the network, during the determined period of the object presence, the requesting UE 804 for SL sensing performs multiple reference signal transmissions 806 towards the object of interest 802 via multiple beam and/or multiple antenna ports, where the UE or a group of candidate UEs 808-814 for SL sensing participation are indicated to perform suitability determination and/or to perform measurements and transmit a report to the transmitting UE, according to the received configuration.

In some embodiments, the determination of a NLOS reception condition for the receive beam at the UE, separately for each transmitted RS or jointly for all/subset of the transmissions, are indicated as a requirement for the candidate UE and/or sensing Rx beam determination.

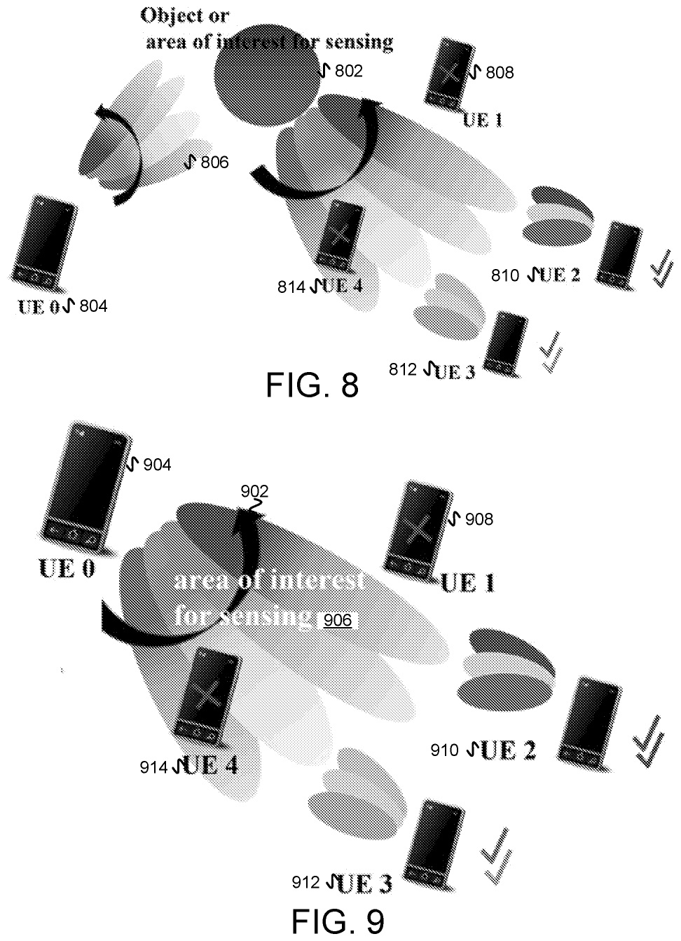

FIG. 9 depicts a scenario where a requesting UE 904 for SL sensing (UE 0) transmits multiple RSs 906 for measurements via different beams towards an area of interest 902, the candidate UEs 908-914 for SL sensing may perform measurements from the received LoS wave via multiple Rx beams and send a report according to the received configuration.

In some embodiments, as depicted in FIG. 9, when an object of interest for sensing is determined to be not present by the requesting UE 904 for SL sensing, or when the intention of a sensing task is to monitor an area occupancy, or a dynamic blockage event in an otherwise blockage-free direction/area, the requesting UE perform multiple RS transmissions 906 towards the area of interest 902 to be monitored via multiple beams and/or multiple antenna ports, where the UE or a group of candidate UEs 908-914 for SL sensing participation are indicated to perform suitability determination and/or to perform measurements over one or multiple Rx beams and transmit a report according to the received configuration.

In some embodiments, the determination of a LOS reception condition for the receive beam at the UE is indicated as a requirement for the sensing UE and/or sensing Rx beam determination, where the LoS determination is done jointly for all of the configured RS resources, or individually, or jointly for subset of the configured RS resources, according to the received configuration.

In some embodiments, a single SL Sensing Request message or a configuration message is used to schedule the plurality of measurements over multiple beams of the same candidate UE for SL sensing, or measurements over multiple candidate UEs where the message is transmitted via a group-common signaling in SL, or a combination thereof.

In some embodiments, some of measurement configuration parameters are constant for multiple measurements or defined relatively. In one implementation, the criterion for UE stationarity and/or the required RSRQ may be defined similarly for multiple measurements, but the time/frequency pattern for related measurements may be multiplexed in time or frequency or code domain and defined with respect to a previously scheduled measurement with an indicated shift in time domain and/or frequency domain and/or code index.

In some embodiments, the UE is requested to send a separate response to each SL Sensing Request message and/or to send a separate report for the conducted measurements, corresponding to the different candidate UE Rx beam measurements and/or different configured requesting UE RS Tx resources/beams for measurements. In some embodiments, the UE is requested to send a joint response to multiple received SL Sensing Request messages and/or to send a joint report for the conducted measurements, corresponding to the multiple candidate UE Rx beam measurements and/or different requesting UE RS Tx beams.

In some embodiments, when UE performs measurements over multiple Rx beams, UE transmits a report only on the best identified beam, or a number of the best identified beams, or on the identified beams that satisfy some conditions (e.g., exceeding a threshold on the RSRQ together with some stationarity condition for the measured beam direction) according to the criteria indicated within the SL UE/beam identification. In some embodiments, when a candidate UE for SL sensing performs measurements over multiple Rx beams and/or different requesting UE RS Tx beams (where each Tx beam correspond to a different RS resource), the candidate UE for SL sensing transmits a report only on the best identified UE Rx beam for a corresponding Tx beam, or a number of the best identified UE Rx beams for a corresponding Tx beam, or the identified UE Rx beams for a corresponding Tx beam that satisfy an indicated condition, or a best Tx beam or a number of the identified best Tx beams, or the identified Tx beams that satisfy some conditions or the best pair of requesting UE for SL sensing Tx beam and the candidate UE Rx beams or a number of the best pairs of Tx beam and the UE Rx beams, or the identified pairs of Tx beam and the UE Rx beams that satisfy an indicated condition, according to the criteria indicated within the SL Sensing Request message or the received configuration. In some embodiments, the obtained measurements are jointly compressed over the multiple candidate UE Rx beams, multiple requesting UE Tx beams or a combination thereof and transmitted to the network as a joint report according to a configuration indicated within the SL Sensing Request message.

In some embodiments, upon reception of a SL Sensing Request message response from candidate sensing UEs for SL sensing, where sufficient suitable sensing candidates/beams are identified (e.g., one candidate for SL sensing or a known number of candidate UEs for SL sensing), the requesting UE terminates the configured measurement task by indicating a de-activation for the remaining configured measurement and reporting procedures.

In some embodiments, the identified candidate UEs for SL sensing participation via a first identification procedure are assigned a group identifier for SL sensing group. In some embodiments, the identified candidate UEs for SL sensing via a first UE identification for SL sensing procedure are considered as a candidate group for the configuration of a second beam refinement and/or UE determination procedure. In one embodiment, the previously identified candidate UEs will receive SL radio sensing request message and measurement configurations via a group signaling. In one embodiment, a larger set of candidate UEs receive the SL radio sensing request message and measurement configurations, but only the UEs previously identified for SL sensing are activated/required to participate in the configured measurements and/or reporting.

When a candidate UE node for SL sensing is required to operate as a sensing Tx, in addition to the UE identification for a specific SL sensing task with UE assistance, the corresponding transmission beam from the assisting UE need to be identified. In some embodiments, the candidate UE Tx beam for sensing is determined based on the transmission of a SL radio sensing request message by the requesting UE for SL sensing, the performed measurements according to the SL radio sensing request message or the received measurements configuration, the response message to the SL radio sensing request message or some combinations thereof.

In some embodiments, the indication of the candidate UE Tx beam includes indication of a QCL type-D relation to a previously used signal or beam. In some embodiments, the Tx beam indication for the candidate UE is done via the QCL type-D relation to one or multiple identified Rx beams, for Rx beam identification/refinement.

In some embodiments, the candidate UE for SL sensing Tx beam is identified based on the transmission of RS by UE nodes and measurements by the network. In some embodiments, the Tx beams for each UE is identified via a QCL type-D relation to another beam, e.g., the number N of the Tx beams closest to an indicated/known beam at the UE.

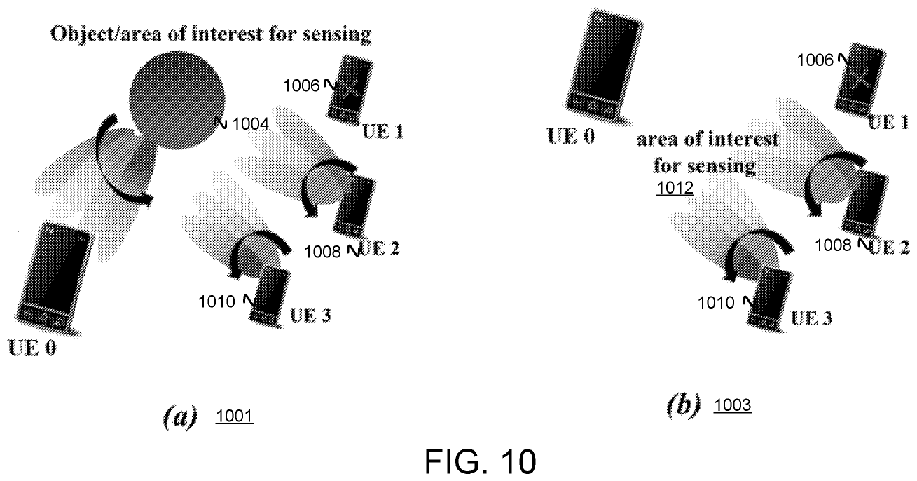

FIG. 10 depicts a scenario where candidate UEs 1006-1010 for SL sensing transmit RS according to the received configuration for the purpose of UE Tx beam refinement, where the RS transmissions are scheduled towards an object of interest 1004, when the object of interest is determined to be present (case (a) 1001), and towards an area of interest to be monitored 1012 (case (b) 1003).

In some embodiments, the transmission of the RS by the candidate UEs 1006-1010 are based on a prior UE identification and/or beam refinement procedure for sensing UEs operating as sensing Rx. In some embodiments, only the UEs previously identified via the same procedure for sensing Rx UE identification are considered for the UE identification and/or beam refinement for UE identification as sensing Tx.

In some embodiments, the RS transmissions from the UEs 1006-1010 are scheduled with resources where the Tx RS resources are separated in time or in frequency or code domain or a combination thereof for all UEs and all Tx beams. In some embodiments, one multiplexing type is used for the Tx beams over the same UE and the same antenna port, whereas one (potentially different) multiplexing type is use for Tx beams over different antenna ports but at the same UE, whereas one (potentially different) multiplexing type is used for the Tx beams over different UEs.

In one embodiment, the RS resources are defined and indicated separately for each UE. In some embodiments, the RS resources are jointly defined and indicated to the UE via a group signaling, towards a group including the candidate UEs for SL sensing.

According to another embodiment directed to joint synchronization and UE/beam identification for SL sensing, the SL synchronization signals, or other signals used for SL time and/or frequency domain synchronization are used for purpose of SL UE and/or beam identification for SL sensing, jointly with time synchronization among the UEs to facilitate a synchronized SL sensing scenario.

In one embodiment, the master information block for SL also includes an indication for additional measurements and/or reporting on the transmitted synchronization signal (e.g., primary sidelink synchronization signal (“PSSS”) and/or secondary sidelink synchronization signal (“SSSS”)) for sensing. In some embodiments, along with the transmission of the synchronization signals, SL radio sensing request message, or a subset of the information elements therein is transmitted.

In some embodiments, multiple sidelink synchronization signals (“SLSS”) are transmitted with different QCL type-D assumptions, where the beam directions cover the object/area of interest for sensing. In some embodiments, upon indication of sensing measurement/report in the MIB-SL, or upon indication of sensing measurement/report in a separate message, the receiving SL UE jointly performs synchronization, measurement, reporting or a combination thereof on the received SLSS.

In some embodiments, when multiple SLSS are transmitted with different QCL type-D assumptions, an index or a set of indices representing the best received beam is included by the candidate UE for sensing in the SL sensing report. In some embodiments, the configuration of the SLSS for joint synchronization and SL sensing suitability evaluation, the subsequent procedure and reporting format is configured by the network at the RRC connected phase of the UEs. In some embodiments, then the candidate UEs are identified within the SL sensing scenario and/or when the candidate UE beams for SL sensing participation have been identified, measurements for beam refinement and/or beam identification are done via an SLSS, where the receiving UE is indicated to perform jointly synchronization, measurement for sensing beam identification/refinement or a combination thereof.

According to another embodiment directed to signaling and message exchange procedure, the SL physical channels and/or dedicated resource pools for sensing measurements/configurations are used for the transmission of SL radio sensing request message, the transmission of the configuration for SL sensing measurements for UE/beam identification for sensing, the transmission of the measurements report and/or the SL radio sensing request message response or a combination thereof.

In some embodiments, the SL radio sensing request message and/or the configuration for SL sensing measurements for UE/beam identification is sent via a dedicated sidelink control information (“SCI”) to single or multiple UEs, or via a broadcast message, e.g., via physical sidelink broadcast channel (“PSBCH”), or via a groupcast message, e.g., via a SCI in physical sidelink control channel (“PSCCH”) with CRC scrambled with a group-common RNTI, where the group-common RNTI is shared among a previously identified group of candidate UEs for SL sensing.

In some embodiments, the SL radio sensing request message response and/or the SL measurement report for UE/beam identification is sent via a dedicated SCI to the requesting UE, or via a broadcast message, e.g., via PSBCH, or via a groupcast message, e.g., via a SCI in PSCCH with CRC scrambled with a group-common RNTI, where the group-common RNTI is shared among a previously identified group of candidate UEs for SL sensing.

In some embodiments, the configurations including the content/type of the SL radio sensing request message and/or the content/type of parts of the information elements within the SL radio sensing request message are configured by network during the connected state of the UEs and remain valid also when they are out of coverage. In this case, the signaling via a SL broadcast or groupcast message or a dedicated SCI within PSCCH includes an activation of the previously configured measurement and/or additional information which together with the previously received information elements from the network constitute the information elements within the SL radio sensing request message and/or additional configuration for SL sensing measurements.

An example would be when the codebooks for the possible type of the information elements, e.g., possible sensing information types and/or sensing QoS and/or stationarity conditions defined in Embodiment 1 within the SL radio sensing request message are communicated via RRC signaling and/or broadcast signaling in SIB, or dedicated or multicast signaling vias PDCCH during the connected UE state, and the codebook index defining the respective information element is transmitted via a dedicated or common SCI or broadcast SL message or a combination thereof. Another example would be when the parameters defining measurement time/frequency resources for SL sensing scenario identification are transmitted by the network, and the SL signaling indicates additional parameters for completion of the time/frequency resource definition, indicates modifications to the received configurations, or indicates the activation of the resources for transmission/reception of the SL measurements.

In some embodiments, when a requesting UE is in the connected state, a SL radio sensing request message is sent to the network. In response, the network configures a sensing scenario and/or dynamically configures resources for transmission of the SL radio sensing request message and/or configures measurements in SL to facilitate identification of the SL UE/beam for sensing participation among the other UEs which are also in the connected state. In some embodiments, when the requesting UE for SL sensing or sensing is in connected mode and the SL sensing scenario is to be established among the UEs in the connected mode, the SL radio sensing request message and other messages transmitted via the requesting UE, the measurements reporting, the SL radio sensing request message response or some combinations thereof are transmitted via PUCCH as an UCI or via PUSCH. In some embodiments, the signaling from the network to the UE nodes in the connected mode participating in the SL sensing UE/beam identification are done via a dedicated or a group-common DCI or via RRC signaling or a combination thereof.

In some embodiments, dedicated SL resource pools are for SL message exchange for sensing configuration and/or sensing measurements. In some embodiments, the waveform parameters inside the SL resource pools for data communication and/or SL configurations related to sensing are different that the waveform parameters for SL resource pools dedicated for sensing measurement. In one embodiment, the cyclic prefix (“CP”) length in the SL resource pools dedicated for sensing measurements are longer compared to the SL resource pools for communication. In some embodiments, the SL resource pools dedicated for sensing measurements are aligned with the resources dedicated for sensing transmissions/receptions in the network, in terms of time, frequency and waveform parameters. In some embodiments, multiple SL resource pools for sensing measurements may follow different waveform parameters, customized to different types of the expected sensing scenarios and sensing task key performance indicators (“KPIs”).

In some embodiments, information elements for part of the SL radio sensing request message is sent via different separately from another part, e.g., via a separate resource and/or signaling mechanism. In some embodiments, information elements for part of the SL radio sensing request message response is sent via different separately from another part, e.g., via a separate resource and/or signaling mechanism.

In some embodiments, when the requesting UE is not connected to the network, but one of a receiving UE is in the connected mode, the connected UE sends a report to the network on the received request and the expected resource occupancy and the expected sensing task. In response, the network may send a configuration message including a collision indication to prevent the expected sensing operation. In another embodiment, the network response may include suggested resources for sensing configuration. In some embodiments, a report from the performed sensing measurements and the configured sensing resources are sent to the network by the connected UEs.

In some embodiments, the beam/resources for transmission of the SL radio sensing request message and/or configuration message for sensing is the same as the beam used for sensing measurements. In some embodiments, some or all of the SL resource pools for sensing may be also used for the purpose of communication when no sensing specific task is available or can be used for the purpose of sensing message exchange. In some embodiments, the requesting UE for SL sensing transmits sensing transmission on a relevant SL resource pool for sensing at the same time or before the SL radio sensing request message and/or SL radio sensing request message response is concluded. In this case, the candidate UEs for SL sensing may perform sensing measurements on the expected SL resource pools for sensing and adjust the measurement and/or report according to the received configuration.

Regarding sensing QOS, for a particular radio sensing task, the information elements defining the sensing QOS as well as the intended sensing information type are summarized as following:

The required/needed sensing information type by UE: in some embodiments, the type of the intended information to be obtained via a sensing procedure is included in the request message. This includes, e.g., indication of the need for object/blockage detection, material/composite estimation, tracking or ranging of an object of interest, estimating the speed of an object of interest. In some embodiments, the needed information is defined explicitly to facilitate scheduling or a proper response determination by the network.

QOS of the needed sensing info: In some embodiments, the required QOS for the requested sensing information is included in the request message by UE. This may include all or any of (but is not limited to) the following sensing QoS information:

Latency: the tolerable latency requirement for the accomplishment of the requested sensing operation. The measurable time duration may be defined as the time-difference from the transmission of the request or reception of the request by the network, to the reception of the response from the network or reception of a sensing RS transmitted in response to the UE request, or accomplishment of the sensing procedure or reception/recovery of the intended sensing information by the UE.

Reliability/Accuracy: information on the accuracy of the obtained information defined via, e.g., tolerable probability of false alarm for detection within an object/area of interest, required probability of detection for detection within an object/area of interest, the tolerable error measure on the envisioned parameter estimation, e.g., estimation of speed or distance of an object of interest.

Request importance: In some embodiments, an indication of the significance of the requested information is also included in the message, as a different/separate information element to the other QoS descriptions for sensing. This may, e.g., indicates the priority of the network for responding positively to the requested service. The UE may include, in the requesting message, a priority identifier/class for different types of requests.

Security/privacy: In some embodiments, the sensing operation is requested to accompany measures for protecting the envisioned (to be extracted) sensing information, any informative propagation/reflection from the object/area of interest that may be used by an unauthorized third-party. The type of the security measure, e.g., object-of-interest sensing information protection, area of interest sensing information protection, requesting-UE identity protection together with the level of required security, e.g., as an integer number defining the required security level, may be included in the request message.

Regarding sensing suitability query for network-based UE-assisted sensing, in order to facilitate UE assisted sensing, the network needs to identify the UE nodes for a specific sensing task which are properly positioned with respect to an object/area of interest. In some embodiments, such determination is done by sending a sensing suitability query message by the network towards a candidate UE or a group of candidate UEs that may participate in the sensing process. In response to the reception of the sensing suitability query message, a UE which satisfies the indicated conditions according to the sensing suitability query message transmits a response to the network.

In some embodiments, upon transmission of the sensing suitability query message and reception of the sensing suitability query message response, network may schedule the identified UE for the associated sensing task, perform further adjustment on the identified candidate UEs, perform further test/verification for UE sensing suitability, or a combination thereof.

According to another embodiment directed to object/area of interest observability for sensing UE, the sensing suitability query message include the definition of the area of interest and/or location of the object of interest which is intended for sensing. This information may be presented within a known coordinate, e.g., a global coordinate system known to the UEs or presented to each UE within its local coordinate system, or via the indication of a previously known object/area of interest or defined relative to a known object/area of interest, or a combination thereof.

In some embodiments, the sensing suitability query may include the condition that the sensing UE must enjoy a LOS condition towards an entity acting as the sensing Tx. In some embodiments, a configuration for the determination of the said LoS condition is included in the sensing suitability query message.

In some embodiments, the sensing suitability query may include the condition that the sensing UE must enjoy a NLOS reception on a specific beam (e.g., identified with an angle corresponding to the object/are of interest). In some embodiments, a configuration for the determination of the said NLOS condition is included in the sensing suitability query message.

In some embodiments, the sensing suitability query message include the required sensing QOS which has to be respected by the participating UE, or requirements on the related UE sensing measurements. This may include, but not limited to, the expected sensing time-duration, expected sensing mode by the UE including sensing Tx or sensing Rx or a combination thereof, the required sensing Tx transmit power, the parameters related to the expected sensing RS and the expected processing/measurements on the sensing RS, the corresponding sensing QoS, or other UE capability elements related to sensing.

According to another embodiment directed to stationarity conditions for sensing UE determination, to facilitate a sensing task with UE assistance over a period of time, according to this embodiment, the sensing suitability query includes a time pattern for which the UE must satisfy some stationarity conditions according to the sensing suitability query.

In some embodiments, the stationarity condition includes for the UE to remain at the same position, or the same velocity, or the same orientation or a combination thereof for an indicated time window. In some embodiments, the stationarity condition is defined over one or multiple specific directions for position stationarity, one or multiple specific directions for velocity stationarity, one or multiple specific direction/angles for orientation stationarity, or some combinations thereof. In some embodiments, the stationarity condition includes one or multiple or separate thresholds to define the stationarity of location or velocity or orientation or a combination thereof along one or multiple defined directions. In some embodiments, the specific directions for position stationarity are defined within the UE local coordinate system or a known coordinated system to the UE.

In some embodiments, multiple stationarity conditions can be defined for the UE where each stationarity condition and the parameters defining the stationarity conditions may be defined separately or in relation to the other or previously defined stationary conditions.

In some embodiments, a stationarity condition may be defined as the UE capability maintaining a beam towards an area/angle/angular region of interest, within a defined period of time.

In some embodiments, the stationarity condition includes a defined time window in the past where the indicated stationarity condition is tested. In some embodiments, the stationarity condition includes an indicated statistical confidence margin, e.g., to satisfy the indicated stationarity condition within the X time window into the future with Y probability.

In some embodiments, the information regarding the LOS/NLOS condition of the candidate UE, the stationarity of a candidate UE, as well as other criterion defined related to the UE suitability for participation are defined with respect to a beam indicated with a QCL type-D relation with an RS known to all of the candidate UEs, a group of candidate UEs or to a single candidate UE or a combination thereof.

According to another embodiment directed to UE response to the Sensing Suitability Query message, in some embodiments, in response to the reception of the sensing suitability query message, a UE which satisfies the indicated conditions within the sensing suitability query message transmits a response to the network.

In some embodiments, the response includes the indication that the UE is determined with the sensing capability and satisfies all the defined criterions, or only a subset of criterions is satisfied. In some embodiments, the UEs where the sensing capability is not determined do not send a report to the network. In some embodiments, when UE capability for sensing is not determined, UE does not send a response to the network. In some embodiments, when UE capability for sensing is not determined, UE sends a response to the network including the set of criterions which are not met, the measurements report, or a combination thereof.

In some embodiments, a report on the performed measurements and other suitability-related values are transmitted to the network via the response message, according to the received configurations and the sensing suitability query message, where the network makes the determination of the UE suitability according to the received measurement report.

In some embodiments, only a subset of the above information elements is included in the request message. In some embodiments, the information embedded within the sensing suitability query message is indicated via an index from a codebook, where the codebook defines different possible values for the abovementioned information elements. In some embodiments, one or multiple codebooks for defining the sensing request information is available, where each codebook includes possible values for one or a subset of the information elements within the message. In some embodiments, codebooks defining the above information elements are defined in accordance to the envisioned use-cases that may be relevant for the UE application. In some embodiments, the information elements within the request message are assumed to hold a default value, unless the value of the information element is explicitly or implicitly defined in the sensing suitability query message. In some embodiments, the possible/supported codebook entries for sensing suitability query message are transferred to the UE from the network. In some embodiments, the said transfer of the supported codebook entries for sensing suitability query message is transmitted by the network to the UE upon indication of satisfying some relevant UE capabilities.

In some embodiments, upon the transmission of sensing suitability query and reception of the response by the network, the single UE or a group of UE devices are identified to participate, or may participate potentially, in a sensing task.

According to another embodiment directed to SL sensing request message, in some embodiments, the UE transmits a SL Sensing Request message in SL towards other UEs as potential candidates for sensing participation, including an indication of a radio sensing request by the transmitting UE, as well as additional information assisting the determination of the suitable sensing UE.

In some embodiments, similar message format/structure and the information elements as for sensing suitability query message (sent by the network to the UE) and radio sensing request message (sent by UE to the network) or a combination or a subset thereof is included in the SL Sensing Request message.

In some embodiments, all or a combination of the information elements defined via the following embodiments are included in the SL Sensing Request message.

According to another embodiment directed to an indication of the radio sensing information/operation type of interest in SL, in some embodiments, the SL Sensing Request message includes the type of the sensing operation expected from the other candidate UEs, including the indication of the sensing Tx or sensing Rx mode, the type of the sensing RS or other RS signal to be used for sensing transmission/reception. In some embodiments, the type of the sensing RS or RS includes the time duration, time-domain resource pattern, total BW, frequency domain resource pattern, or a subset of the sensing RS-defining parameters.

In some embodiments, the SL Sensing Request message includes the definition of the sensing information type needed by the requesting UE, e.g., definition of an intended material/composite estimation of an object of interest, tracking or ranging of an object of interest, detecting a potential object/blockage, estimating the velocity of an object of interest with respect to a global coordinate system, or a coordinate system known by the UE and the group of potentially participating UEs in the SL sensing. In some embodiments, the sensing information type further includes the type of the expected measurement/report from the candidate UE for sensing.

In some embodiments, the SL Sensing Request message includes an indication of the required QOS for the requested sensing information is included in the request message by UE. This may include all or any of latency, reliability/accuracy of the required sensing information, request importance/priority, security/privacy, or a combination thereof as defined within elements of sensing QoS.

This may include, but not limited to, the expected sensing time-duration, expected sensing mode by the UE including sensing Tx or sensing Rx or a combination thereof, the required sensing Tx transmit power or other UE capability related elements.

In some embodiments, the SL Sensing Request message includes an indication of a time/periodicity/repetition pattern of an intended sensing task to be done by the candidate UE, time information when the sensing information is needed, the periodicity or time-interval between the two requested sensing operation, the number of the requested radar sensing operation or total time duration for which the requested sensing operation needs to be repeated. In some embodiments, sensing request refers to a time-point in the future, e.g., the sensing operation is requested to be done after 1 sec and before 2 secs with respect to the request message time or some known time reference. In this case, the expected time-of-interest for performing the required sensing task is included in the UE request message. In some embodiments, the request includes a validity period, e.g., a time duration for which the request is still valid.

According to another embodiment directed to object/area of interest observability for sensing UE, the SL Sensing Request message includes the definition of an area of interest and/or location of the object of interest which is intended for sensing.

In some embodiments, the SL Sensing Request message includes an indication of the object or area of interest via an object ID when the object may be previously known to the other UEs, or via location information defining the object/area of interest for sensing/monitoring or information defining the direction of interest for sensing/monitoring.

In some embodiments, the location or directional/angular information is according to a local coordinate system known to the candidate UEs, a global coordinate system, a beam identifier where the area of interest is of the same direction as a known previous transmission by that beam. In some embodiments, the object/area of interest is defined in relation to a known object by the other UEs. In one implementation, the angular direction or beam associated with the object of interest is indicated via a QCL type-D relation with a common network beam/signal or a previously transmitted UE beam/signal, where additional information defining the relative angle, relative displacement of object/area of interest in relation to the known beam.

In some embodiments, the SL Sensing Request message include the condition that the sensing UE must enjoy a LOS condition towards the transmitting UE. In some embodiments, a configuration for the determination of the said LoS condition is included in the SL Sensing Request message or has been previously configured by the network.

In some embodiments, the SL Sensing Request message includes the condition that the sensing UE must enjoy a NLOS reception on a specific beam. In some embodiments, a configuration for the determination of the said NLOS condition is included in the SL Sensing Request message or has been previously configured by the network.

According to another embodiment directed to stationarity conditions for sensing UE determination, to facilitate SL sensing with an assisting UE over a period of time, according to this embodiment, the SL Sensing Request message includes a time pattern for which the candidate UE must satisfy some stationarity conditions according to the SL Sensing Request message.

In some embodiments, the stationarity condition includes for the UE to remain at the same position, or the same velocity, or the same orientation or a combination thereof for an indicated time window. In some embodiments, the stationarity condition is defined over one or multiple specific directions for position stationarity, one or multiple specific directions for velocity stationarity, one or multiple specific direction/angle for orientation stationarity, or some combinations thereof. In some embodiments, the stationarity condition includes one or multiple or separate thresholds to define the stationarity of location or velocity or orientation or a combination thereof along one or multiple defined directions. In some embodiments, the specific directions for position stationarity are defined within the UE local coordinate system or a known coordinated system to the UE.

In some embodiments, multiple stationarity conditions can be defined for the UE where each stationarity condition and the parameters defining the stationarity conditions may be defined separately or in relation to the other or previously defined stationary conditions.

In some embodiments, a stationarity condition may be defined as the UE capability maintaining a beam towards an area/angle/angular region of interest, within a defined period of time.

In some embodiments, the stationarity condition includes a defined time window in the past where the indicated stationarity condition is tested. In some embodiments, the stationarity condition includes an indicated statistical confidence margin, e.g., to satisfy the indicated stationarity condition within the X time window into the future with Y probability.

According to another embodiment directed to synchronization and connected state for candidate UE for SL sensing, to facilitate SL sensing with an assisting UE, depending on the specific sensing type and/or sensing QoS of interest, the requirements on participating UEs in SL sensing may be different. According to this embodiment, the requirements on time synchronization and/or connected state of the candidate UEs are included in the SL radio sensing request message.

In some embodiments, as part of the SL sensing request message response and/or the measurements report for SL sensing UE/beam identification, the synchronization status of the candidate UEs for SL sensing are included in the response/report.

In some embodiments, in-coverage condition is indicated as a requirement for candidate UE for participating in SL sensing. In some embodiments, the in-coverage requirement is relaxed, but with an indication of a time-window from the latest instance of time-synchronization with the network and/or a maximum level of time-misalignment for the candidate UE for SL sensing. In some embodiments, the indication of the latest synchronization RS type and/or the reference node used for synchronization are included in the report to the requesting node for SL sensing.

In some embodiments, the in-coverage status and/or the use of a UE-based RS for synchronization is accompanied with a Cell ID in order to distinguish the nodes with non-similar network nodes as their reference point for synchronization.

In some embodiment, the method of synchronization, the used synchronization RS, as well as the time duration from the last synchronization operation or a combination thereof are used to establish the synchronization status/accuracy.

In some embodiments, an index from a codebook is indicated by the requesting UE to define the required criterion/requirement on the synchronization status for SL sensing participation, where the codebook includes different valid synchronization status for SL sensing. In some embodiments, this is determined based on the intended use-case/application of SL sensing by the requesting UE and/or the desired sensing QoS. Upon reception of the indication of the criterion/requirement on the synchronization status, in some embodiments, only the UEs which satisfy the indicated criterion will respond to the received SL sensing request message.

In some embodiments, the candidate UEs are indicated with a request to participate in a re-synchronization procedure upon participation in the sensing procedure. In some embodiments, upon identification of a UE for SL sensing participation, the identified UE will be configured with resources for synchronization by the requesting UE or by the network, depending on the in-coverage status of the identified UEs for SL sensing.

In some embodiments, when a dedicated procedure for SL synchronization for sensing is to be configured by the requesting UE for SL sensing, the requirements on the candidate UE synchronization status is relaxed or canceled.

In some embodiments, an index from a codebook is indicated by the requesting UE to define the required criterion/requirement on the synchronization status for SL sensing participation, where the codebook includes different valid synchronization status for SL sensing. In some embodiments, this is determined based on the intended use-case/application of SL sensing by the requesting UE and/or the desired sensing QoS.

In some embodiments, the synchronization priority/quality order is re-defined (different from what is specified for communications) to reflect the needs of SL sensing, e.g., the UEs with potentially lower synchronization mismatch to the requesting UE and/or other UEs as the candidate UEs for SL sensing participation will be considered with a higher priority.

In some embodiments, the need to additional synchronization procedure and/or the type of the measurement configuration for SL sensing beam identification and/or beam refinement will be determined based on the received reports on the synchronization status.

In some embodiments, the synchronization status is defined as an estimate of the clock mismatch between the candidate UE for SL sensing and a reference node, e.g., the network node. In some embodiments, the mismatch is defined in terms of the expected error, or error variance.

In some embodiments, the requirement to report and/or consider synchronization status as a criterion is defined via the SL sensing request message.

In some embodiments, a SL Sensing Request message for repeating a previously granted/performed sensing operation is made via a repetition indication, combined with a reference to a previously performed sensing operation. The said indicator may include an identification number for the previously performed sensing operation or referring to the n-th previously performed sensing operation. In some embodiments, a request message refers to the n-th previously sent request message, which was not necessarily granted.

In some embodiments, the request message refers to a previously performed sensing operation or a previously sent request message with some additional information for modification. In one implementation, the previously sent but not-granted request message is indicated, together with a different level of sensing QoS, e.g., a lower required range resolution. In one implementation, a previously sent request is referenced, together with an updated sensing duration.

In some embodiments, only a subset of the above information elements is included in the request message. In some embodiments, the information embedded within the SL Sensing Request message is indicated via an index from a codebook, where the codebook defines different possible values for the abovementioned information elements. In some embodiments, one or multiple codebooks for defining the sensing request information is available, where each codebook includes possible values for one or a subset of the information elements within the message. In some embodiments, codebooks defining the above information elements are defined in accordance to the envisioned use-cases that may be relevant for the UE application. In some embodiments, the information elements within the request message are assumed to hold a default value, unless the value of the information element is explicitly or implicitly defined in the request message. In some embodiments, the possible/supported codebook entries for SL Sensing Request message are transferred to the UE from the network or transferred from the requesting UE via a configuration message from the requesting UE or the initial synchronization process in the SL. In some embodiments, the said transfer of the supported codebook entries for UE sensing request is transmitted by the network upon indication of the relevant UE capability or a service request.

In some embodiments, the information regarding the LOS/NLOS condition of the candidate UE, the stationarity of a candidate UE, as well as other criterion defined related to the UE suitability for participation are defined with respect to a beam indicated with a QCL type-D relation with a RS known to all of the candidate UEs, a group of candidate UEs or to a single candidate UE or a combination thereof.

According to another embodiment directed to SL sensing request message response, in response to the reception of the SL Sensing Request message and/or, if configured, the performed measurements, a UE which satisfies the indicated conditions within the SL Sensing Request message transmits a response to the requesting UE.

In some embodiments, the response includes the indication that the UE is determined with the sensing capability and satisfies the defined criteria. In some embodiments, the UEs where the sensing capability is not determined do not send a response. In some embodiments, when UE capability for sensing is not determined, UE sends a response to the including the set of criterions which are not met, a measurements report when the suitability determination of the candidate UE is based on a configured measurement, a suggestion for a different sensing requirement which would be feasible with the candidate UE or a combination thereof.

In some embodiments, the information elements indicating the satisfaction of the UE capability for sensing participation is included in the response message.

In some embodiments, a report on the performed measurements and other suitability-related criterion are included in the response message, according to the received configurations for sensing measurements and the SL Sensing Request message and/or the configuration received from network, where the requesting UE makes the determination of the candidate UE suitability for sensing according to the received measurement report.

In some embodiments, when the response is transmitted over a shared SL channel among a group of candidate UEs, the response message is sent also in a group-cast manner whereby the candidate UEs also monitor the response from the other UEs. In some embodiments, upon the detection of a sufficient number of the positive response from the candidate UEs, a candidate UE terminates its measurement process for sensing suitability determination, do not send a response even if the sensing suitability criterions are satisfied.

In some embodiments, upon the reception of SL Sensing Request message response a UE or a group of UE devices are identified to participate in the SL sensing operation. In some embodiments, upon reception of the sufficient responses from the candidate UEs satisfying the needed requirements, the requesting UE sends a termination message to the group of UE candidates to indicate that no further contribution is needed.

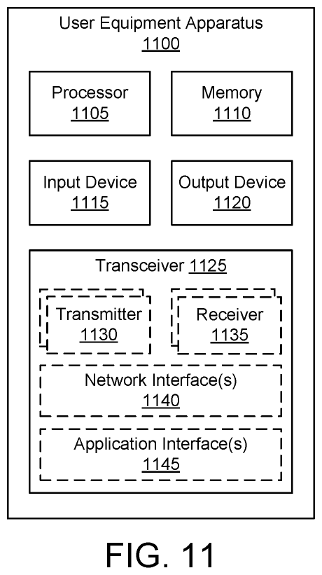

FIG. 11 depicts a user equipment apparatus 1100 that may be used for techniques for beam identification for radio sensing participation, according to embodiments of the disclosure.

In various embodiments, the user equipment apparatus 1100 is used to implement one or more of the solutions described above. The user equipment apparatus 1100 may be one embodiment of a UE, such as the remote unit 105 and/or the UE 205, as described above. Furthermore, the user equipment apparatus 1100 may include a processor 1105, a memory 1110, an input device 1115, an output device 1120, and a transceiver 1125. In some embodiments, the input device 1115 and the output device 1120 are combined into a single device, such as a touchscreen. In certain embodiments, the user equipment apparatus 1100 may not include any input device 1115 and/or output device 1120. In various embodiments, the user equipment apparatus 1100 may include one or more of: the processor 1105, the memory 1110, and the transceiver 1125, and may not include the input device 1115 and/or the output device 1120.

As depicted, the transceiver 1125 includes at least one transmitter 1130 and at least one receiver 1135. Here, the transceiver 1125 communicates with one or more base units 121. Additionally, the transceiver 1125 may support at least one network interface 1140 and/or application interface 1145. The application interface(s) 1145 may support one or more APIs. The network interface(s) 1140 may support 3GPP reference points, such as Uu and PC5. Other network interfaces 1140 may be supported, as understood by one of ordinary skill in the art.

The processor 1105, in one embodiment, may include any known controller capable of executing computer-readable instructions and/or capable of performing logical operations. For example, the processor 1105 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1105 executes instructions stored in the memory 1110 to perform the methods and routines described herein. The processor 1105 is communicatively coupled to the memory 1110, the input device 1115, the output device 1120, and the transceiver 1125. In certain embodiments, the processor 1105 may include an application processor (also known as “main processor”) which manages application-domain and operating system (“OS”) functions and a baseband processor (also known as “baseband radio processor”) which manages radio functions.

The memory 1110, in one embodiment, is a computer readable storage medium. In some embodiments, the memory 1110 includes volatile computer storage media. For example, the memory 1110 may include a RAM, including dynamic RAM (“DRAM”), synchronous dynamic RAM (“SDRAM”), and/or static RAM (“SRAM”). In some embodiments, the memory 1110 includes non-volatile computer storage media. For example, the memory 1110 may include a hard disk drive, a flash memory, or any other suitable non-volatile computer storage device. In some embodiments, the memory 1110 includes both volatile and non-volatile computer storage media.

In some embodiments, the memory 1110 stores data related to CSI enhancements for higher frequencies. For example, the memory 1110 may store parameters, configurations, resource assignments, policies, and the like as described above. In certain embodiments, the memory 1110 also stores program code and related data, such as an operating system or other controller algorithms operating on the user equipment apparatus 1100, and one or more software applications.

The input device 1115, in one embodiment, may include any known computer input device including a touch panel, a button, a keyboard, a stylus, a microphone, or the like. In some embodiments, the input device 1115 may be integrated with the output device 1120, for example, as a touchscreen or similar touch-sensitive display. In some embodiments, the input device 1115 includes a touchscreen such that text may be input using a virtual keyboard displayed on the touchscreen and/or by handwriting on the touchscreen. In some embodiments, the input device 1115 includes two or more different devices, such as a keyboard and a touch panel.

The output device 1120, in one embodiment, is designed to output visual, audible, and/or haptic signals. In some embodiments, the output device 1120 includes an electronically controllable display or display device capable of outputting visual data to a user. For example, the output device 1120 may include, but is not limited to, an LCD display, an LED display, an OLED display, a projector, or similar display device capable of outputting images, text, or the like to a user. As another, non-limiting, example, the output device 1120 may include a wearable display separate from, but communicatively coupled to, the rest of the user equipment apparatus 1100, such as a smart watch, smart glasses, a heads-up display, or the like. Further, the output device 1120 may be a component of a smart phone, a personal digital assistant, a television, a table computer, a notebook (laptop) computer, a personal computer, a vehicle dashboard, or the like.

In certain embodiments, the output device 1120 includes one or more speakers for producing sound. For example, the output device 1120 may produce an audible alert or notification (e.g., a beep or chime). In some embodiments, the output device 1120 includes one or more haptic devices for producing vibrations, motion, or other haptic feedback. In some embodiments, all or portions of the output device 1120 may be integrated with the input device 1115. For example, the input device 1115 and output device 1120 may form a touchscreen or similar touch-sensitive display. In other embodiments, the output device 1120 may be located near the input device 1115.

The transceiver 1125 includes at least transmitter 1130 and at least one receiver 1135. The transceiver 1125 may be used to provide UL communication signals to a base unit 121 and to receive DL communication signals from the base unit 121, as described herein. Similarly, the transceiver 1125 may be used to transmit and receive SL signals (e.g., V2X communication), as described herein. Although only one transmitter 1130 and one receiver 1135 are illustrated, the user equipment apparatus 1100 may have any suitable number of transmitters 1130 and receivers 1135. Further, the transmitter(s) 1130 and the receiver(s) 1135 may be any suitable type of transmitters and receivers. In one embodiment, the transceiver 1125 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1125, transmitters 1130, and receivers 1135 may be implemented as physically separate components that access a shared hardware resource and/or software resource, such as for example, the network interface 1140.

In various embodiments, one or more transmitters 1130 and/or one or more receivers 1135 may be implemented and/or integrated into a single hardware component, such as a multi-transceiver chip, a system-on-a-chip, an ASIC, or other type of hardware component. In certain embodiments, one or more transmitters 1130 and/or one or more receivers 1135 may be implemented and/or integrated into a multi-chip module. In some embodiments, other components such as the network interface 1140 or other hardware components/circuits may be integrated with any number of transmitters 1130 and/or receivers 1135 into a single chip. In such embodiment, the transmitters 1130 and receivers 1135 may be logically configured as a transceiver 1125 that uses one more common control signals or as modular transmitters 1130 and receivers 1135 implemented in the same hardware chip or in a multi-chip module.

In one embodiment, the memory 1110 includes instructions that are executable by the processor 1105 to receive a first configuration for performing and reporting radio sensing suitability measurements for radio sensing assistance associated with a radio sensing task, perform radio sensing suitability measurements for a radio sensing scenario according to the first configuration to determine whether the apparatus is suitable for providing the radio sensing assistance associated with the radio sensing task, transmit a suitability report comprising the performed radio sensing suitability measurements according to the first configuration, and receive, in response to the determining that the apparatus is suitable for providing the radio sensing assistance associated with the radio sensing task according to the performed radio sensing suitability measurements, a second configuration for performing radio sensing operations.

In one embodiment, the first configuration comprises one or more of a set of time resources, frequency resources, or beam resources to receive a reference signal for radio sensing suitability measurements for the radio sensing scenario, a second configuration for the transmitted reference signal for radio sensing measurements, a set of time resources, frequency resources, or beam resources for transmitting the suitability report, criteria for sensing suitability determination for the radio sensing scenario based on the radio sensing suitability measurements, criteria for transmission of sensing suitability report based on the radio sensing suitability measurements, and a type of report to be transmitted based on an evaluation of sensing suitability criteria.

In one embodiment, the instructions are executable by the processor 1105 to cause the apparatus 1100 to report the performed radio sensing suitability measurements to the network node in response to one or more of satisfying a suitability criteria and determining that a number of positively responding nodes does not exceed a predetermined threshold.

In one embodiment, the radio sensing scenario comprises one or more of an indication of an object or target of interest to be monitored via radio sensing, an indication of an area or angle of interest to be monitored via radio sensing, and a type of the radio sensing task.

In one embodiment, the first configuration comprises at least two transmission beams for radio sensing suitability measurements.

In one embodiment, the suitability report further comprises one or more of a first report on a first transmission beam and a second report on a second transmission beam for radio sensing suitability measurements, a single report on multiple transmission beams for radio sensing suitability measurements, a single report on multiple reception beams for radio sensing suitability measurements, a single report on a plurality of transmission and reception beam pairs for radio sensing suitability measurements, at least two reports on the configured transmission beams for radio sensing suitability measurements, and at least two reports on the configured transmission beams where multiple reports correspond to different receiving beams at the UE.

In one embodiment, the radio sensing suitability measurements for the radio sensing scenario comprises at least one of a LOS and a NLOS reception condition for a receive beam at the UE.

In one embodiment, the instructions are executable by the processor 1105 to cause the apparatus 1100 to transmit one or more of a LOS reception report and a NLOS reception report on different reception filters.

In one embodiment, the radio sensing suitability measurements for the radio sensing scenario comprises a stationarity condition for radio sensing during a time period of interest.

In one embodiment, the suitability report comprising the performed radio sensing measurements is transmitted jointly in response to multiple requests to perform radio sensing suitability measurements for radio sensing assistance associated with a radio sensing task.

In one embodiment, the instructions are executable by the processor 1105 to cause the apparatus 1100 to perform radio sensing suitability measurements for a radio sensing scenario according to the first configuration over one or more of multiple transmission beams and multiple reception beams to refine the corresponding transmission beam and reception beam for radio sensing.

In one embodiment, the first configuration is for performing and reporting radio sensing suitability measurements for radio sensing assistance associated with a sidelink-based sensing task.

In one embodiment, the instructions are executable by the processor 1105 to cause the apparatus 1100 to use sidelink synchronization signals for beam identification for the sidelink-based sensing task, jointly with time synchronization among a plurality of UEs to facilitate a synchronized sidelink sensing scenario.

In one embodiment, the instructions are executable by the processor 1105 to cause the apparatus 1100 to use multiple sidelink resource pools for performing radio sensing measurements, the multiple sidelink resource pools associated with different waveform parameters that are defined for different radio sensing scenarios and different radio sensing tasks.

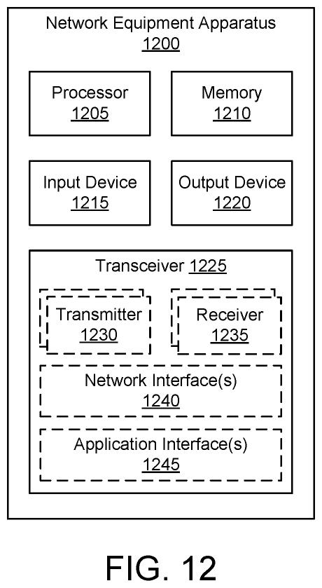

FIG. 12 depicts one embodiment of a network apparatus 1200 that may be used for techniques for beam identification for radio sensing participation, according to embodiments of the disclosure. In some embodiments, the network apparatus 1200 may be one embodiment of a RAN node and its supporting hardware, such as the base unit 121 and/or gNB, described above. Furthermore, network apparatus 1200 may include a processor 1205, a memory 1210, an input device 1215, an output device 1220, and a transceiver 1225. In certain embodiments, the network apparatus 1200 does not include any input device 1215 and/or output device 1220.

As depicted, the transceiver 1225 includes at least one transmitter 1230 and at least one receiver 1235. Here, the transceiver 1225 communicates with one or more remote units 105. Additionally, the transceiver 1225 may support at least one network interface 1240 and/or application interface 1245. The application interface(s) 1245 may support one or more APIs. The network interface(s) 1240 may support 3GPP reference points, such as Uu, N1, N2, N3, N5, N6 and/or N7 interfaces. Other network interfaces 1240 may be supported, as understood by one of ordinary skill in the art.

When implementing an NEF, the network interface(s) 1240 may include an interface for communicating with an application function (i.e., N5) and with at least one network function (e.g., UDR, SFC function, UPF) in a mobile communication network, such as the mobile core network 130.

The processor 1205, in one embodiment, may include any known controller capable of executing computer-readable instructions and/or capable of performing logical operations. For example, the processor 1205 may be a microcontroller, a microprocessor, a CPU, a GPU, an auxiliary processing unit, an FPGA, a DSP, a co-processor, an application-specific processor, or similar programmable controller. In some embodiments, the processor 1205 executes instructions stored in the memory 1210 to perform the methods and routines described herein. The processor 1205 is communicatively coupled to the memory 1210, the input device 1215, the output device 1220, and the transceiver 1225. In certain embodiments, the processor 1205 may include an application processor (also known as “main processor”) which manages application-domain and OS functions and a baseband processor (also known as “baseband radio processor”) which manages radio function. In various embodiments, the processor 1205 controls the network apparatus 1200 to implement the above described network entity behaviors (e.g., of the gNB) for techniques for beam identification for radio sensing participation.

The memory 1210, in one embodiment, is a computer readable storage medium. In some embodiments, the memory 1210 includes volatile computer storage media. For example, the memory 1210 may include a RAM, including DRAM, SDRAM, and/or SRAM. In some embodiments, the memory 1210 includes non-volatile computer storage media. For example, the memory 1210 may include a hard disk drive, a flash memory, or any other suitable non-volatile computer storage device. In some embodiments, the memory 1210 includes both volatile and non-volatile computer storage media.

In some embodiments, the memory 1210 stores data relating to CSI enhancements for higher frequencies. For example, the memory 1210 may store parameters, configurations, resource assignments, policies, and the like as described above. In certain embodiments, the memory 1210 also stores program code and related data, such as an OS or other controller algorithms operating on the network apparatus 1200, and one or more software applications.

The input device 1215, in one embodiment, may include any known computer input device including a touch panel, a button, a keyboard, a stylus, a microphone, or the like. In some embodiments, the input device 1215 may be integrated with the output device 1220, for example, as a touchscreen or similar touch-sensitive display. In some embodiments, the input device 1215 includes a touchscreen such that text may be input using a virtual keyboard displayed on the touchscreen and/or by handwriting on the touchscreen. In some embodiments, the input device 1215 includes two or more different devices, such as a keyboard and a touch panel.

The output device 1220, in one embodiment, may include any known electronically controllable display or display device. The output device 1220 may be designed to output visual, audible, and/or haptic signals. In some embodiments, the output device 1220 includes an electronic display capable of outputting visual data to a user. Further, the output device 1220 may be a component of a smart phone, a personal digital assistant, a television, a table computer, a notebook (laptop) computer, a personal computer, a vehicle dashboard, or the like.

In certain embodiments, the output device 1220 includes one or more speakers for producing sound. For example, the output device 1220 may produce an audible alert or notification (e.g., a beep or chime). In some embodiments, the output device 1220 includes one or more haptic devices for producing vibrations, motion, or other haptic feedback. In some embodiments, all or portions of the output device 1220 may be integrated with the input device 1215. For example, the input device 1215 and output device 1220 may form a touchscreen or similar touch-sensitive display. In other embodiments, all or portions of the output device 1220 may be located near the input device 1215.

As discussed above, the transceiver 1225 may communicate with one or more remote units and/or with one or more interworking functions that provide access to one or more PLMNs. The transceiver 1225 may also communicate with one or more network functions (e.g., in the mobile core network 80). The transceiver 1225 operates under the control of the processor 1205 to transmit messages, data, and other signals and also to receive messages, data, and other signals. For example, the processor 1205 may selectively activate the transceiver (or portions thereof) at particular times in order to send and receive messages.

The transceiver 1225 may include one or more transmitters 1230 and one or more receivers 1235. In certain embodiments, the one or more transmitters 1230 and/or the one or more receivers 1235 may share transceiver hardware and/or circuitry. For example, the one or more transmitters 1230 and/or the one or more receivers 1235 may share antenna(s), antenna tuner(s), amplifier(s), filter(s), oscillator(s), mixer(s), modulator/demodulator(s), power supply, and the like. In one embodiment, the transceiver 1225 implements multiple logical transceivers using different communication protocols or protocol stacks, while using common physical hardware.

In one embodiment, the memory 1210 includes instructions that are executable by the processor 1205 to transmit, to a UE, a first configuration for performing and reporting radio sensing suitability measurements for radio sensing assistance associated with a radio sensing task, receive, from the UE, a suitability report comprising radio sensing suitability measurements performed according to the first configuration, determine, based on the radio sensing suitability measurements, whether the UE is suitable for providing the radio sensing assistance associated with the radio sensing task, and transmit, to the UE in response to the UE being suitable for providing the radio sensing assistance associated with the radio sensing task, a second configuration for performing radio sensing operations.

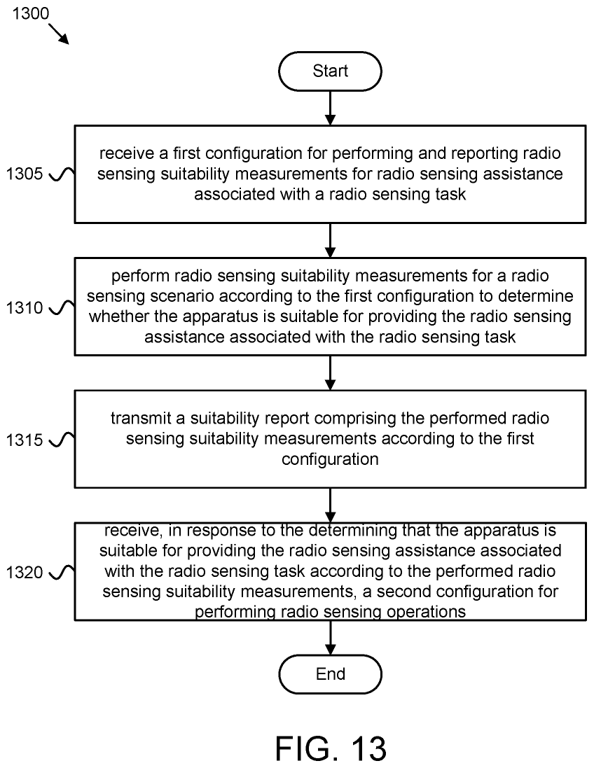

FIG. 13 is a flowchart diagram of a method 1300 for techniques for beam identification for radio sensing participation. The method 1300 may be performed by a UE as described herein, for example, the remote unit 105 and/or the user equipment apparatus 1100. In some embodiments, the method 1300 may be performed by a processor executing program code, for example, a microcontroller, a microprocessor, a CPU, a GPU, an auxiliary processing unit, a FPGA, or the like.

In one embodiment, the method 1300 begins and receives 1305 a first configuration for performing and reporting radio sensing suitability measurements for radio sensing assistance associated with a radio sensing task. In one embodiment, the method 1300 performs 1305 radio sensing suitability measurements for a radio sensing scenario according to the first configuration to determine whether the apparatus is suitable for providing the radio sensing assistance associated with the radio sensing task. In one embodiment, the method 1300 transmits 1315 a suitability report comprising the performed radio sensing suitability measurements according to the first configuration. In one embodiment, the method 1300 receives 1320, in response to the determining that the apparatus is suitable for providing the radio sensing assistance associated with the radio sensing task according to the performed radio sensing suitability measurements, a second configuration for performing radio sensing operations, and the method 1300 ends.

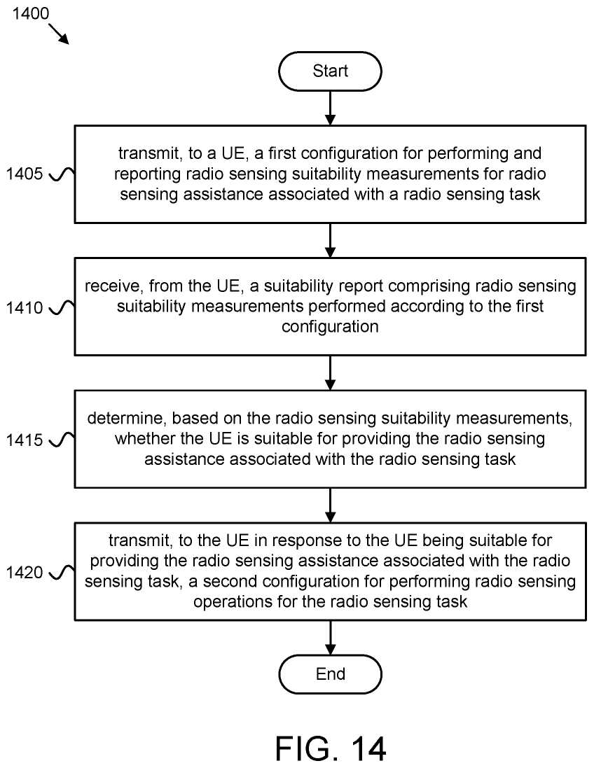

FIG. 14 is a flowchart diagram of a method 1400 for techniques for beam identification for radio sensing participation. The method 1400 may be performed by a UE as described herein, for example, the remote unit 105 and/or the user equipment apparatus 1100, and/or by a network device such as base unit 121, a gNB, and/or the network equipment apparatus 1200. In some embodiments, the method 1400 may be performed by a processor executing program code, for example, a microcontroller, a microprocessor, a CPU, a GPU, an auxiliary processing unit, a FPGA, or the like.

In one embodiment, the method 1400 begins and transmits 1405, to a UE, a first configuration for performing and reporting radio sensing suitability measurements for radio sensing assistance associated with a radio sensing task. In one embodiment, the method 1400 receives 1410, from the UE, a suitability report comprising radio sensing suitability measurements performed according to the first configuration. In one embodiment, the method 1400 determines 1415, based on the radio sensing suitability measurements, whether the UE is suitable for providing the radio sensing assistance associated with the radio sensing task. In one embodiment, the method 1400 transmits 1420, to the UE in response to the UE being suitable for providing the radio sensing assistance associated with the radio sensing task, a second configuration for performing radio sensing operations for the radio sensing task, and the method 1400 ends.

A first apparatus is disclosed for techniques for beam identification for radio sensing participation. The first apparatus may include a UE as described herein, for example, the remote unit 105 and/or the user equipment apparatus 1100. In some embodiments, the first apparatus may include a processor executing program code, for example, a microcontroller, a microprocessor, a CPU, a GPU, an auxiliary processing unit, a FPGA, or the like.

In one embodiment, the first apparatus includes a processor and a memory coupled to the processor. The memory includes instructions that are executable by the processor to receive a first configuration for performing and reporting radio sensing suitability measurements for radio sensing assistance associated with a radio sensing task, perform radio sensing suitability measurements for a radio sensing scenario according to the first configuration to determine whether the apparatus is suitable for providing the radio sensing assistance associated with the radio sensing task, transmit a suitability report comprising the performed radio sensing suitability measurements according to the first configuration, and receive, in response to the determining that the apparatus is suitable for providing the radio sensing assistance associated with the radio sensing task according to the performed radio sensing suitability measurements, a second configuration for performing radio sensing operations.

In one embodiment, the first configuration comprises one or more of a set of time resources, frequency resources, or beam resources to receive a reference signal for radio sensing suitability measurements for the radio sensing scenario, a second configuration for the transmitted reference signal for radio sensing measurements, a set of time resources, frequency resources, or beam resources for transmitting the suitability report, criteria for sensing suitability determination for the radio sensing scenario based on the radio sensing suitability measurements, criteria for transmission of sensing suitability report based on the radio sensing suitability measurements, and a type of report to be transmitted based on an evaluation of sensing suitability criteria.

In one embodiment, the instructions are executable by the processor to cause the apparatus to report the performed radio sensing suitability measurements to the network node in response to one or more of satisfying a suitability criteria and determining that a number of positively responding nodes does not exceed a predetermined threshold.

In one embodiment, the radio sensing scenario comprises one or more of an indication of an object or target of interest to be monitored via radio sensing, an indication of an area or angle of interest to be monitored via radio sensing, and a type of the radio sensing task.

In one embodiment, the first configuration comprises at least two transmission beams for radio sensing suitability measurements.

In one embodiment, the suitability report further comprises one or more of a first report on a first transmission beam and a second report on a second transmission beam for radio sensing suitability measurements, a single report on multiple transmission beams for radio sensing suitability measurements, a single report on multiple reception beams for radio sensing suitability measurements, a single report on a plurality of transmission and reception beam pairs for radio sensing suitability measurements, at least two reports on the configured transmission beams for radio sensing suitability measurements, and at least two reports on the configured transmission beams where multiple reports correspond to different receiving beams at the apparatus.

In one embodiment, the radio sensing suitability measurements for the radio sensing scenario comprises at least one of a LOS and a NLOS reception condition for a receive beam at the apparatus.

In one embodiment, the instructions are executable by the processor to cause the apparatus to transmit one or more of a LOS reception report and a NLOS reception report on different reception filters.

In one embodiment, the radio sensing suitability measurements for the radio sensing scenario comprises a stationarity condition for radio sensing during a time period of interest.

In one embodiment, the suitability report comprising the performed radio sensing measurements is transmitted jointly in response to multiple requests to perform radio sensing suitability measurements for radio sensing assistance associated with a radio sensing task.

In one embodiment, the instructions are executable by the processor to cause the apparatus to perform radio sensing suitability measurements for a radio sensing scenario according to the first configuration over one or more of multiple transmission beams and multiple reception beams to refine the corresponding transmission beam and reception beam for radio sensing.

In one embodiment, the first configuration is for performing and reporting radio sensing suitability measurements for radio sensing assistance associated with a sidelink-based sensing task.

In one embodiment, the instructions are executable by the processor to cause the apparatus to use sidelink synchronization signals for beam identification for the sidelink-based sensing task, jointly with time synchronization among a plurality of apparatuses to facilitate a synchronized sidelink sensing scenario.

In one embodiment, the instructions are executable by the processor to cause the apparatus to use multiple sidelink resource pools for performing radio sensing measurements, the multiple sidelink resource pools associated with different waveform parameters that are defined for different radio sensing scenarios and different radio sensing tasks.

A first method is disclosed for techniques for beam identification for radio sensing participation. The first method may be performed by a UE as described herein, for example, the remote unit 105 and/or the user equipment apparatus 1100. In some embodiments, the first method may be performed by a processor executing program code, for example, a microcontroller, a microprocessor, a CPU, a GPU, an auxiliary processing unit, a FPGA, or the like.

In one embodiment, the first method receives, at a UE, a first configuration for performing and reporting radio sensing suitability measurements for radio sensing assistance associated with a radio sensing task and performs, by the UE, radio sensing suitability measurements for a radio sensing scenario according to the first configuration to determine whether the UE is suitable for providing the radio sensing assistance associated with the radio sensing task. In one embodiment, the first method transmits, by the UE, a suitability report comprising the performed radio sensing suitability measurements to a network node according to the first configuration and receives, by the UE and in response to the UE being suitable for providing the radio sensing assistance associated with the radio sensing task according to the performed radio sensing suitability measurements, a second configuration for performing radio sensing operations.

In one embodiment, the first configuration comprises one or more of a set of time resources, frequency resources, or beam resources to receive a reference signal for radio sensing suitability measurements for the radio sensing scenario, a second configuration for the transmitted reference signal for radio sensing measurements, a set of time resources, frequency resources, or beam resources for transmitting the suitability report, criteria for sensing suitability determination for the radio sensing scenario based on the radio sensing suitability measurements, criteria for transmission of sensing suitability report based on the radio sensing suitability measurements, and a type of report to be transmitted based on an evaluation of sensing suitability criteria.

In one embodiment, the first method reports the performed radio sensing suitability measurements to the network node in response to one or more of satisfying a suitability criteria and determining that a number of positively responding nodes does not exceed a predetermined threshold.

In one embodiment, the radio sensing scenario comprises one or more of an indication of an object or target of interest to be monitored via radio sensing, an indication of an area or angle of interest to be monitored via radio sensing, and a type of the radio sensing task.

In one embodiment, the first configuration comprises at least two transmission beams for radio sensing suitability measurements.

In one embodiment, the suitability report further comprises one or more of a first report on a first transmission beam and a second report on a second transmission beam for radio sensing suitability measurements, a single report on multiple transmission beams for radio sensing suitability measurements, a single report on multiple reception beams for radio sensing suitability measurements, a single report on a plurality of transmission and reception beam pairs for radio sensing suitability measurements, at least two reports on the configured transmission beams for radio sensing suitability measurements, and at least two reports on the configured transmission beams where multiple reports correspond to different receiving beams at the UE.

In one embodiment, the radio sensing suitability measurements for the radio sensing scenario comprises at least one of a LOS and a NLOS reception condition for a receive beam at the UE.

In one embodiment, the first method transmits one or more of a LOS reception report and a NLOS reception report on different reception filters.

In one embodiment, the radio sensing suitability measurements for the radio sensing scenario comprises a stationarity condition for radio sensing during a time period of interest.

In one embodiment, the suitability report comprising the performed radio sensing measurements is transmitted jointly in response to multiple requests to perform radio sensing suitability measurements for radio sensing assistance associated with a radio sensing task.

In one embodiment, the first method performs radio sensing suitability measurements for a radio sensing scenario according to the first configuration over one or more of multiple transmission beams and multiple reception beams to refine the corresponding transmission beam and reception beam for radio sensing.

In one embodiment, the first configuration is for performing and reporting radio sensing suitability measurements for radio sensing assistance associated with a sidelink-based sensing task.

In one embodiment, the first method uses sidelink synchronization signals for beam identification for the sidelink-based sensing task, jointly with time synchronization among a plurality of UEs to facilitate a synchronized sidelink sensing scenario.

In one embodiment, the first method uses multiple sidelink resource pools for performing radio sensing measurements, the multiple sidelink resource pools associated with different waveform parameters that are defined for different radio sensing scenarios and different radio sensing tasks.

A second apparatus is disclosed for techniques for beam identification for radio sensing participation. The second apparatus may include a UE as described herein, for example, the remote unit 105 and/or the user equipment apparatus 1100, and/or by a network device such as base unit 121, a gNB, and/or the network equipment apparatus 1200. In some embodiments, the second apparatus may include a processor executing program code, for example, a microcontroller, a microprocessor, a CPU, a GPU, an auxiliary processing unit, a FPGA, or the like.

In one embodiment, the second apparatus includes a processor and a memory coupled to the processor. The memory includes instructions that are executable by the processor to transmit, to a UE, a first configuration for performing and reporting radio sensing suitability measurements for radio sensing assistance associated with a radio sensing task, receive, from the UE, a suitability report comprising radio sensing suitability measurements performed according to the first configuration, determine, based on the radio sensing suitability measurements, whether the UE is suitable for providing the radio sensing assistance associated with the radio sensing task, and transmit, to the UE in response to the UE being suitable for providing the radio sensing assistance associated with the radio sensing task, a second configuration for performing radio sensing operations.

A second method is disclosed for techniques for beam identification for radio sensing participation. The second method may be performed by a UE as described herein, for example, the remote unit 105 and/or the user equipment apparatus 1100, and/or by a network device such as base unit 121, a gNB, and/or the network equipment apparatus 1200. In some embodiments, the second method may be performed by a processor executing program code, for example, a microcontroller, a microprocessor, a CPU, a GPU, an auxiliary processing unit, a FPGA, or the like.

In one embodiment, the second method transmits, to a UE, a first configuration for performing and reporting radio sensing suitability measurements for radio sensing assistance associated with a radio sensing task and receives, from the UE, a suitability report comprising radio sensing suitability measurements performed according to the first configuration. In one embodiment, the second method determines, based on the radio sensing suitability measurements, whether the UE is suitable for providing the radio sensing assistance associated with the radio sensing task. In one embodiment, the second method transmits, to the UE in response to the UE being suitable for providing the radio sensing assistance associated with the radio sensing task, a second configuration for performing radio sensing operations.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code.

This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

1. A user equipment (UE) for wireless communication, comprising:
at least one memory; and
at least one processor coupled with the at least one memory and configured to cause the UE to:
receive a first configuration for performing and reporting radio sensing suitability measurements for radio sensing assistance associated with a radio sensing task;
perform radio sensing suitability measurements for a radio sensing scenario according to the first configuration to determine whether the UE is suitable for providing the radio sensing assistance associated with the radio sensing task;
transmit a suitability report comprising the radio sensing suitability measurements according to the first configuration; and
receive, in response to determining that the UE is suitable for providing the radio sensing assistance associated with the radio sensing task according to the radio sensing suitability measurements, a second configuration for performing radio sensing operations.

2. The UE of claim 1, wherein the first configuration comprises:
a set of time resources, frequency resources, beam resources, or a combination thereof, to receive a reference signal for radio sensing suitability measurements for the radio sensing scenario;
a second configuration for the reference signal for radio sensing suitability measurements;
a set of time resources, frequency resources, beam resources, or a combination thereof for transmitting the suitability report;
criteria for sensing suitability determination for the radio sensing scenario based on the radio sensing suitability measurements;
criteria for transmission of sensing suitability report based on the radio sensing suitability measurements;
a type of report to be transmitted based on an evaluation of sensing suitability criteria; or
a combination thereof.

3. The UE of claim 1, wherein the at least one processor is configured to cause the UE to report the radio sensing suitability measurements in response to satisfying a suitability criteria or determining that a number of positively responding nodes does not exceed a predetermined threshold.

4. The UE of claim 1, wherein the radio sensing scenario comprises an indication of an object or target of interest to be monitored via radio sensing, an indication of an area or angle of interest to be monitored via radio sensing, a type of the radio sensing task, or a combination thereof.

5. The UE of claim 1, wherein the first configuration comprises at least two transmission beams for radio sensing suitability measurements.

6. The UE of claim 1, wherein the suitability report further comprises a first report on a first transmission beam and a second report on a second transmission beam for radio sensing suitability measurements, a single report on multiple transmission beams for radio sensing suitability measurements, a single report on multiple reception beams for radio sensing suitability measurements, a single report on a plurality of transmission and reception beam pairs for radio sensing suitability measurements, at least two reports on the transmission beams for radio sensing suitability measurements, at least two reports on the transmission beams where multiple reports correspond to different receiving beams at the UE, or a combination thereof.

7. The UE of claim 1, wherein the radio sensing suitability measurements for the radio sensing scenario comprises a line of sight (“LOS”) reception condition for a receive beam at the UE, a non-LOS (“NLOS”) reception condition for a receive beam at the UE, or a combination thereof.

8. The UE of claim 7, wherein the at least one processor is configured to cause the UE to transmit a LOS reception report on different reception filters, a NLOS reception report on different reception filters, or a combination thereof.

9. The UE of claim 1, wherein the radio sensing suitability measurements for the radio sensing scenario comprises a stationarity condition for radio sensing during a time period of interest.

10. The UE of claim 1, wherein the suitability report comprising the radio sensing suitability measurements is transmitted jointly in response to multiple requests to perform radio sensing suitability measurements for radio sensing assistance associated with a radio sensing task.

11. The UE of claim 1, wherein the at least one processor is configured to cause the UE to perform radio sensing suitability measurements for a radio sensing scenario according to the first configuration over one or more of multiple transmission beams and multiple reception beams to refine a corresponding transmission beam and reception beam for radio sensing.

12. The UE of claim 1, wherein the first configuration is for performing and reporting radio sensing suitability measurements for radio sensing assistance associated with a sidelink-based sensing task.

13. The UE of claim 12, wherein the at least one processor is configured to cause the UE to:
use sidelink synchronization signals for beam identification for the sidelink-based sensing task, jointly with time synchronization among a plurality of UEs to facilitate a synchronized sidelink sensing scenario; or
use multiple sidelink resource pools for performing radio sensing suitability measurements, the multiple sidelink resource pools associated with different waveform parameters that are defined for different radio sensing scenarios and different radio sensing tasks.

14. A method performed by a user equipment (UE), comprising:
receiving a first configuration for performing and reporting radio sensing suitability measurements for radio sensing assistance associated with a radio sensing task;
performing radio sensing suitability measurements for a radio sensing scenario according to the first configuration to determine whether the UE is suitable for providing the radio sensing assistance associated with the radio sensing task;
transmitting a suitability report comprising the radio sensing suitability measurements according to the first configuration; and
receiving, in response to determining that the UE is suitable for providing the radio sensing assistance associated with the radio sensing task according to the radio sensing suitability measurements, a second configuration for performing radio sensing operations.

15. A network entity for wireless communication, comprising:
at least one memory; and
at least one processor coupled with the at least one memory and configured to cause the network entity to:
transmit, to a user equipment (UE), a first configuration for performing and reporting radio sensing suitability measurements for radio sensing assistance associated with a radio sensing task;
receive, from the UE, a suitability report comprising radio sensing suitability measurements performed according to the first configuration;
determine, based on the radio sensing suitability measurements, whether the UE is suitable for providing the radio sensing assistance associated with the radio sensing task; and
transmit, to the UE, in response to determining that the UE is suitable for providing the radio sensing assistance associated with the radio sensing task, a second configuration for performing radio sensing operations.

16. A processor for wireless communication, comprising:
at least one controller coupled with at least one memory and configured to cause the processor to:
receive a first configuration for performing and reporting radio sensing suitability measurements for radio sensing assistance associated with a radio sensing task;
perform radio sensing suitability measurements for a radio sensing scenario according to the first configuration to determine whether the processor is suitable for providing the radio sensing assistance associated with the radio sensing task;
transmit a suitability report comprising the radio sensing suitability measurements according to the first configuration; and
receive, in response to determining that the processor is suitable for providing the radio sensing assistance associated with the radio sensing task according to the radio sensing suitability measurements, a second configuration for performing radio sensing operations.

17. The processor of claim 16, wherein the first configuration comprises:
a set of time resources, frequency resources, beam resources, or a combination thereof, to receive a reference signal for radio sensing suitability measurements for the radio sensing scenario;
a second configuration for the reference signal for radio sensing suitability measurements;
a set of time resources, frequency resources, beam resources, or a combination thereof for transmitting the suitability report;
criteria for sensing suitability determination for the radio sensing scenario based on the radio sensing suitability measurements;
criteria for transmission of sensing suitability report based on the radio sensing suitability measurements;
a type of report to be transmitted based on an evaluation of sensing suitability criteria; or
a combination thereof.

18. The processor of claim 16, wherein the at least one controller is configured to cause the processor to report the radio sensing suitability measurements in response to satisfying a suitability criteria or determining that a number of positively responding nodes does not exceed a predetermined threshold.

19. The processor of claim 16, wherein the radio sensing scenario comprises an indication of an object or target of interest to be monitored via radio sensing, an indication of an area or angle of interest to be monitored via radio sensing, a type of the radio sensing task, or a combination thereof.

20. The processor of claim 16, wherein the first configuration comprises at least two transmission beams for radio sensing suitability measurements.
